(19) United States
(12) Patent Application Publication
(10) Pub. No.: US 2015/0173410 A1
(43) Pub. Date: Jun. 25, 2015

(54) BEVERAGE COMPRISING OMEGA FATTY ACID

(71) Applicant: Change Cola, Inc., Roanoke, VA (US)

(72) Inventors: James PHILLIPS, Roanoke, VA (US); Kevin CONWAY, Cornelius, NC (US)

(21) Appl. No.: 14/577,872

(22) Filed: Dec. 19, 2014

Related U.S. Application Data
(60) Provisional application No. 61/918,242, filed on Dec. 19, 2013.

(51) Int. Cl. A23L 2/54; A23L 1/30

(52) U.S. Cl. CPC A23L 2/54; A23L 1/3008; A23V 2002/00

(57) ABSTRACT

Provided herein are drinks (e.g., carbonated drinks) comprising one or more unsaturated fatty acids (e.g., an omega-3, omega-6, and/or omega-9) fatty acids, wherein the drinks are characterized by a low glycemic index and/or an enhanced non-refrigerated shelf life.

### CROSS-REFERENCE TO RELATED APPLICATIONS

This application claims priority benefit to U.S. Provisional Appl. No. 61/918,242, filed Dec. 19, 2013, the contents of which are hereby incorporated by reference in their entirety.

### BACKGROUND OF THE INVENTION

1. Field of the Invention

Composition of beverages and methods for preparing beverages that contain additives, such as nutraceuticals, pharmaceuticals, supplements, and nutritional supplements.

2. Background Art

There is an epidemic of obesity that is prevalent in the United States and is beginning to spread around the world. According to the American Heart Association; the total excess cost related to the current prevalence of adolescent overweight and obesity is estimated to be $254 billion $208 billion in lost productivity secondary to premature morbidity and mortality and $46 billion in direct medical costs. If current trends in the growth of obesity continue, total healthcare costs attributable to obesity could reach $861 to $957 billion by 2030, which would account for 16% to 18% of US health expenditures.

### BRIEF SUMMARY OF THE INVENTION

In certain aspects, the present application provides a beverage comprising one or more unsaturated fatty acids, wherein the beverage is a carbonated beverage characterized by a low glycemic index (e.g., 55 or less), an enhanced non-refrigerated shelf life, or a combination thereof.

In some embodiments, the one or more unsaturated fatty acids comprise at least one unsaturated fatty acid selected from the group consisting of omega-3 fatty acids, omega-6 fatty acids, and omega-9 fatty acids. In some embodiments, the one or more unsaturated fatty acids (e.g., as described hereinabove) comprise at least one polyunsaturated fatty acid selected from the group consisting of hexadecatrienoic acid, alpha-linolenic acid, stearidonic acid, eicosatrienoic acid, eicosatetraenoic acid, eicosapentaenoic acid, heneicosapcntaenoic acid, docosapentacnoic acid (n-3), docosahexaenoic acid, tetracosapentaenoic acid, tetracosahexaenoic acid, linoleic acid, gamma-linolenic acid, eicosadienoic acid, dihomo-gamma-linolenic acid, arachidonic acid, docosadienoic acid, adrenic acid, docosapentaenoic acid (n-6), tetracosatetraenoic acid, tetracosapentaenoic acid, mead acid, and a mixture thereof. In some embodiments, the one or more unsaturated fatty acids comprise at least one polyunsaturated fatty acid selected from the group consisting of eicosapentaenoic acid, docosapentaenoic acid (n-3), docosahexacnoic acid, arachidonic acid, and docosapentaenoic acid (n-6).

In some embodiments, the one or more unsaturated fatty acids (e.g., as described hereinabove) are provided in an encapsulated form. In some embodiments, the one or more unsaturated fatty acids (e.g., as described hereinabove) is provided in a form having a low protein content.

In some embodiments, the beverage is characterized by the CO₂ concentration in the beverage. In some embodiments, the beverage has a CO₂ concentration greater than 0.5% (e.g., in the range of 0.5% to 7.0% v/v).

In some embodiments, the beverage is characterized by the container for the beverage. In some embodiments, the beverage is included in a container that blocks light (e.g., container that blocks 80% or more UV light).

In certain aspects, the present application provides a carbonated beverage comprising: (a) one or more polyunsaturated fatty acids, e.g., in an amount of 12 mg to 75 mg per 10 oz of the beverage; (b) a CO₂ concentration, e.g., in the range of 0.5% to 7.0% v/v; and (c) a syrup having a pH of 0.05 to 5 (e.g., 1, 2, 3, 4, or 5) diluted with water, e.g., in a ratio of between 1:3 and 1:7 by volume of the syrup to water. In some embodiments, the carbonated beverage includes eicosapentaenoic acid and docosahexaenoic acid, e.g., in an amount of 32 mg per 10 oz of the beverage.

In some embodiments, the carbonated beverage (e.g., as described hereinabove) comprising a sweetener selected from the group consisting of fructose, Monk fruit extract, Monatin, and combinations thereof. In some embodiments, the sweetener is Monatin. In some embodiments, the sweetener is fructose.

In some embodiments, the one or more polyunsaturated fatty acids (e.g., as described hereinabove) are provided in an encapsulated form. In some embodiments, the one or more polyunsaturated fatty acids (e.g., as described hereinabove) is provided in a form having a low protein level.

In some embodiments, the carbonated beverage is characterized by the container for the carbonated beverage. In some embodiments, the carbonated beverage is included in a container that blocks light (e.g., container that blocks 80% or more UV light).

In some embodiments, the carbonated beverage is characterized by a low glycemic index (e.g., 55 or less). In some embodiments, the carbonated beverage is characterized by an enhanced non-refrigerated shelf life. In some embodiments, the carbonated beverage has a low turbidity.

In some embodiments, the carbonated beverage described herein above further comprises at least one ingredient selected from the group consisting of vitamins, minerals, fiber, pH adjusters, emulsion stabilizers, non-polar solvents, phytochemicals, lipoic acid, coenzymes, sweeteners, caffeine, flavors, preservatives, and surfactants.

In certain aspects, the present application provides a carbonated drink comprising an omega additive, wherein the carbonated drink is low glycemic, and has an enhanced non-refrigerated shelf life.

In some embodiments, the enhanced shelf life refers to shelf life observed when the drink is exposed to sunlight and in non-refrigerated environment having a temperature of over 70° F. In some embodiments, said shelf life is enabled by way of two of: CO2 of 0.5% to 7.0%, a nitrogen purge prior to crowning or closure, packaging having a transmission of UV light of less than 20%.

In some embodiments, the omega is prevented from omega rancidity by way of two of: the presence of CO2 greater than 0.5%, nitrogen purge prior to crowning or closure, a container that blocks 80% or more of UV light.

In some embodiments, microbial growth of the carbonated drink is restricted by way of CO2 greater than 0.5%. In some embodiments, the carbonated drink comprises a CO2 of 0.5% to 7.0% and omega 3 level of 5 mg to 100 mg. In some embodiments, the taste of said drink is impacted by way of a pH of 1 to 7 and CO2 greater than 0.5%. In some embodiments, the drink contains no binders. In some embodiments, the omega delivered in the carbonated drink comprises DHA+EPA of 32 mg or more per 10 oz of carbonated drink. In some embodiments, the omega is without mercury. In some embodiments, said omega is one of omega 3, omega 6. In some embodiments, said omega is encapsulated. In some embodiments, said omega has a reduced level of proteins. In some embodiments, said drink is of low turbidity. In some embodiments, said drink comprises one of: Fructose or Monk fruit extract. In some embodiments, said drink is without preservatives. In some embodiments, said drink is without caffeine. In some embodiments, said drink can be a cola. In some embodiments, said drink can be a mostly clear soda. In some embodiments. Benzyl Alcohol is added as a preservative. In some embodiments, said drink is with caffeine.

In certain aspects, the present application provides a carbonated beverage that comprises an omega fatty acid; within the range of 12 mg to 75 mg per 10 oz of drink, CO2: within the range of 0.5% to 7.0% v/v, Sweetener: with a sweetness profile largely matching sugar with a Brix of syrup @20 C of 10 to 80 Brix. Soda: with a water to syrup ratio of 1 part syrup to 3 parts water, up to a 1 part syrup to 7 parts water, PH of Syrup: @20 C 0.05 to 5.

In some embodiments, the carbonated beverage has an enhanced shelf life. In some embodiments, the enhanced shelf life refers to shelf life observed when the drink is exposed to direct sunlight and in non-refrigerated environment having a temperature of over 70° F. In some embodiments, the shelf life is enabled by way of two of: CO2 of 0.5% to 7.0%, a nitrogen purge prior to crowning or closure, packaging having a transmission of UV light of less than 20%.

In some embodiments, the omega is prevented from omega rancidity by way of one of: the presence of CO2 greater than 0.5%, nitrogen purge prior to crowning or closure. In some embodiments, the beverage contains no binders. In some embodiments, the omega delivered in the carbonated beverage comprises DHA+EPA of 32 mg or more per 10 oz of carbonated beverage. In some embodiments, the omega is without mercury. In some embodiments, said omega is one of omega 3, omega 6. In some embodiments, said omega is encapsulated. In some embodiments, said omega has a reduced level of proteins. In some embodiments, said beverage is of low turbidity. In some embodiments, said beverage comprises one of: Fructose, Monk fruit extract, Monatin, a natural sweetener. In some embodiments, said beverage comprises is without preservatives. In some embodiments, said beverage is without caffeine. In some embodiments, said beverage can be a cola soda. In some embodiments, said beverage can be a non-cola soda.

In some embodiments, said beverage is packaged in a metal container. In some embodiments, said beverage is packaged in a UV blocking PET container. In some embodiments, said beverage is packaged in a UV blocking glass container.

In some embodiments, Monk Fruit Extract is substituted for Fructose. In some embodiments, an artificial sweetener is substituted for fructose. In some embodiments, sugar is substituted for fructose.

In some embodiments, one said carbonated beverage comprises one of the following flavors, fruit flavors, such as guava, kiwi, peach, mango, papaya, pineapple, banana, strawberry, raspberry, blueberry, orange, grapefruit, tangerine, lemon, lime and lemon-lime; cola flavors, tea flavors, coffee flavors, chocolate flavors, dairy flavors, root beer and birch beer flavor.

In some embodiments, said beverage comprises an artificial sweetener. In some embodiments, Benzyl Alcohol is added as a preservative. In some embodiments, said beverage is with caffeine. In some embodiments, said beverage is without caffeine.

### BRIEF DESCRIPTION OF THE DRAWINGS/FIGURES

FIG. 1 shows packaging that blocks at least 80% of UV Light.

### DETAILED DESCRIPTION OF THE INVENTION

US Overweight & Obesity—2012 Statistical Facts

Among Americans age 20 and older, 149.3 million are overweight or obese (BMI of 25.0 kg/m2 and higher):

78.0 million men.
71.3 million women.

Of these, 75.0 million are obese (BMI of 30.0 kg/m2 and higher):

34.9 million men.
40.1 million women.

Among Americans age 20 and older, the following are overweight or obese (BMI of 25.0 and higher):

For non-Hispanic whites. 72.3 percent of men and 59.3 percent of women.
For non-Hispanic blacks, 70.8 percent of men and 77.7 percent of women.
For Mexican Americans, 77.5 percent of men and 75.1 percent of women.

Of these, the following are obese (BMI of 30.0 and higher):

For non-Hispanic whites, 32.1 percent of men and 32.8 percent of women.
For non-Hispanic blacks, 37.0 percent of men and 51.0 percent of women.
For Mexican Americans. 31.4 percent of men and 43.4 percent of women.

From 1977 to 2002, Americans doubled their consumption of a sweetened beverage trend that was paralleled by doubling the prevalence of obesity. The consumption of sugar-sweetened beverages is associated with weight and obesity, and changes in consumption can help predict changes in weight. One study followed 548 schoolchildren over 19 months and found that changes in soft drink consumption were associated with changes in body mass index (BMI). Each soft drink that a child added to his or her daily consumption was accompanied by an increase in BMI of 0.24 kg/m2. Similarly, an 8-year study of 50,000 female nurses compared women who went from drinking almost no soft drinks to drinking more than one a day to women who went from drinking more than one soft drink a day to drinking almost no soft drinks. The women who increased their consumption of soft drinks gained 8.0 kg over the course of the study while the women who decreased their consumption gained only 2.8 kg. In each of these studies, the absolute number of soft drinks consumed per day was also positively associated with weight gain.

It remains possible that the correlation is due to a third factor: people who lead unhealthy lifestyles might consume more soft drinks. If so, then the association between soft drink consumption and weight gain could reflect the consequences of an unhealthy lifestyle rather than the consequences of consuming soft drinks. Experimental evidence is needed to definitively establish the causal role of soft drink consumption. Reviews of the experimental evidence suggest that soft drink consumption does cause weight gain, but the effect is often small except for overweight individuals.

Many of these experiments examined the influence of sugar-sweetened soft drinks on weight gain in children and adolescents. In one experiment, adolescents replaced sugar-sweetened soft drinks in their diet with artificially sweetened soft drinks that were sent to their homes over 25 weeks. Compared with children in a control group, children who received the artificially sweetened drinks saw a smaller increase in their BMI (by −0.14 kg/m2), but this effect was only statistically significant among the heaviest children (who saw a benefit of −0.75 kg/m2). In another study, an educational program encouraged schoolchildren to consume fewer soft drinks. During the school year, the prevalence of obesity decreased among children in the program by 0.2%, compared to a 7.5% increase among children in the control group.

Sugar-sweetened drinks have also been speculated to cause weight gain in adults. In one study, overweight individuals consumed a daily supplement of sucrose-sweetened or artificially sweetened drinks or foods for a 10 week period. Most of the supplement was in the form of soft drinks. Individuals in the sucrose group gained 1.6 kg, and individuals in the artificial-sweetener group lost 1.0 kg. A two week study had participants supplement their diet with sugar-sweetened soft drinks, artificially sweetened soft drinks, or neither. Although the participants gained the most weight when consuming the sugar-sweetened drinks, some of the differences were unreliable: the differences between men who consumed sugar-sweetened drinks or no drinks was not statistically significant.

Other research suggests that soft drinks could play a special role in weight gain. One four-week experiment compared a 450 calorie/day supplement of sugar-sweetened soft drinks to a 450 calorie/day supplement of jelly beans. The jelly bean supplement did not lead to weight gain, but the soft drink supplement did. The likely reason for the difference in weight gain is that people who consumed the jelly beans lowered their caloric intake at subsequent meals, while people who consumed soft drinks did not. Thus, the low levels of satiety provided by sugar-sweetened soft drinks may explain their association with obesity. That is, people who consume calories in sugar-sweetened beverages may fail to adequately reduce their intake of calories from other sources. Indeed, people consume more total calories in meals and on days when they are given sugar-sweetened beverages than when they are given artificially sweetened beverages or water.

A study by Purdue University reported that no-calorie sweeteners were linked to an increase in body weight. The experiment compared rats that were fed saccharin—sweetened yogurt and glucose-sweetened yogurt. The saccharin group eventually consumed more calories, gained more weight and more body fat, and did not compensate later by cutting back.

The consumption of sugar-sweetened soft drinks can also be associated with many weight-related diseases, including diabetes, metabolic syndrome and cardiovascular risk factors, and elevated blood pressure

The inventors believe that the beverage industry is in part contributing to this rise of obesity in the US and globally. The US Beverage industry is a $75.7 billion annual revenue industry. The US public in 2011 consumed 9.3 billion cases of soda with the majority being non-diet. It is well known that non-diet soda such as Coke has little nutritional value and is a high glycemic drink. Thus there is a need for a cola/soda substitute that provides nutritional value and is a low glycemic drink. Omega fatty acids would prove to be an outstanding nutritional supplement that if added to soda or cola could provide a profound beneficial health benefit.

Omega fatty acids such as omega 3, 6, 9 provide are important for all systems of the body to function normally, including your skin, respiratory system, circulatory system, brain and organs. There are two fatty acids, termed essential fatty acids (EFA) that your body does not produce on its own. EFAs have to be ingested. The two essential fatty acids that the human body cannot produce are the omega-3 fatty acid and omega-6 fatty acid, which are important for brain development, immune system function and blood pressure regulation.

Research on the health benefits of omega-3 fatty acid have shown that it may be useful for supporting, for example, the following conditions: Asthma. Diabetes, Arthritis, Osteoporosis, certain Cancers, Skin Disorders, High Cholesterol, High Blood Pressure, Attention Disorders, Depressive Disorders, Macular Degeneration, Digestive Difficulties.

The American Heart Association recommends eating fish (particularly fatty fish) at least two times (two servings) a week. Each serving is 3.5 ounce cooked, or about ¾ cup of flaked fish. Fatty fish like salmon, mackerel, herring, lake trout, sardines and albacore tuna are high in omega-3 fatty acids.

Omega-6 fatty acid (e.g., Linoleic Acid) combined with omega-3 fatty acid produces many of the health benefits described above, but the trickiest part about playing the fatty acid game is that it is best to eat them in the right amounts.

It is recommended to eat twice as much omega-6 as omega-3, so that your omega-6 to omega-3 ratio is 2:1, but in today's world of fast food, frozen entrees, and high calorie snacks, it is not uncommon for most people to actually be getting about 15 times more omega-6 than omega-3. Washington D.C.'s center for Genetics, Nutrition and Health suggest that eating omega-6 and omega-3 in the wrong proportions may actually negate the health benefits.

The best sources of omega-6 include seeds, nuts and grains and green leafy vegetables, like lettuce, broccoli, purslane and kale, and in certain raw vegetable oils. Care should be taken to use raw cold pressed vegetable oils because cooking destroys the benefits of the fatty acids.

Within the body omega-3 fatty acids are converted to DHA and EPA (docosahexaenoic acid and eicosapentaenoic acid, respectively). DHA and EPA are highly unsaturated fatty acids that play very important roles, e.g., in the vision development and brain function of infants.

One study found significantly lower amounts of EPA in the cells of patients who had attempted suicide, suggesting that omega-3 fatty acids may actually play a role in suicide prevention. A lack of DHA has been associated with diseases including Alzheimer disease, attention disorders, phenylketonuria, cystic fibrosis and others. Blue green algae is an exemplary good source of EPA and DHA.

Omega-9, or monounsaturated oleic and stearic acid, is a non essential fatty acid produced naturally by the body whenever there is enough of either Omega 3 and 6 essential fatty acids. However, if you do not have enough omega 3 and omega 6, then you must get omega 9 externally, e.g., from your diet. This fatty acid plays a role in preventing heart disease by lowering cholesterol levels. Other benefits of omega 9 are known, for example, it reduces hardening of the arteries and improves immune function

While omega fatty acid can be so beneficial as a nutritional supplement, there have been numerous hurdles to overcome that have prevented them from being utilized in carbonated drinks such as cola and soda. These include poor water solubility, turbidity, bad after taste, bad breath, and digestive issues such as; burping, gas and indigestion. In addition, omega fatty acid provides a source for microbial activity, which can cause the omega enhanced drink to become rancid. Therefore the storage and shelf life have also been a limiting issue for manufacturing and selling a viable omega enhanced carbonated drink.

US Patent Application US 2012/0016026 A1, US 2011/0236364 A1 and US 2011/0117184 A1 discloses the possibility of adding omega fatty acids into a carbonated drink, the content of each of these applications are incorporated herein by reference in their entirety. For example, these patent applications disclose encapsulating the omega fatty acids and remove certain omega proteins can reduce, if not eliminate, the poor after taste and also eliminate many, if not most, of the digestive issues associated with omega fatty acids.

There is a need to provide an omega enhanced “low glycemic” carbonated drink. In some embodiments, the present application is directed to an omega enhanced carbonated drink (e.g., low glycemic carbonated drink) with an enhanced non-refrigerated shelf live, which is capable of being exposed to sun light when stored. In some embodiments, the present application is directed to an omega enhanced carbonated drink (e.g., low glycemic carbonated drink) that maintains its taste (e.g., maintains a highly acceptable taste) once bottled.

Definitions of Terms and examples as provided herein:

Open terms such as “include,” “including,” “contain,” “containing” and the like mean “comprising.”

As used herein, “a” or “an” means one or more unless otherwise specified.

Unless specifically stated or obvious from context, as used herein, the term “about” is understood as within a range of normal tolerance in the art, for example, within 20% of the stated value, for example. “about 20” includes 16 to 24, and “about 20%” includes 16% to 24% (not 0% to 40%). As used herein, “about” a specific value also includes the specific value, for example, about 10% includes 10%.

Additive: (Additive and Supplement are meant herein to have the same meaning. An additive and a supplement, for example, can be a nutritional additive or supplement.) includes anything that one can add to a food, beverage, or other human consumable, to enhance one or more of its nutritional, pharmaceutical, dietary, health, nutraceutical, health benefit, energy-providing, treating, holistic, or other properties. For example, provided herein are compositions and methods for preparing foods, beverages and other aqueous human consumables, that include one or more additives, typically oil based additives (e.g., non-polar compounds), such as nutraceuticals, pharmaceuticals, vitamins. typically oil soluble vitamins, for example. Vitamin D. Vitamin E, and Vitamin A, minerals, fatty acids, e.g., essential fatty acids, e.g., polyunsaturated fatty acids, for example, omega-3 fatty acids, omega-6 fatty acids and omega-9 fatty acids, for example, alpha-linolenic acid (ALA), docosahexaenoic acid (DHA), eicosapentaenoic acid (EPA), gamma-linolenic acid (GLA), conjugated linoleic acid (CLA), oleic acid, saw palmetto extract, flaxseed oil, fish oil, algae oil, phytosterols, resveratrol, lipoic acid, carotenoids, for example lutein, zeaxanthin and lycopene, and coenzymes, for example, Coenzyme Q10 and other additives.

Algae oil or algal oil: refers to any oil derived from an algal source, e.g., marine dinoflagellates, for example, microalgae, for example, Crypthecodinium sp., particularly, Crypthecodinium cohnii. In one example, algae oil is used as a non-polar compound, for example, as an active ingredient, in the compositions described herein. The algae oil typically contains DHA. In one example, the algae oil also is a source of EPA.

In some examples, non-polar compounds containing for example, Omega-3 PUFAs, particularly DHA (and optionally EPA), that can be used as the non-polar compound in the compositions described herein are oils derived from microorganisms. In some embodiments, the oils are derived from marine dinoflagellates, for example, microalgae, for example, Crypthecodinium sp, particularly, Crypthecodinium cohnii. Microalgae oils are an excellent source of omega-3 fatty acids, particularly DHA (see e.g., U.S. Pat. Nos. 5,397,591, 5,407,957, 5,492,938 and 5,711,983). Exemplary of oils derived from microalgae are the oils disclosed in, and oils made according to the methods described in, U.S. Pat. Nos. 5,397,591, 5,407,957, 5,492,938 and 5,711,983 and U.S. Publication number 2007/0166411, including DHASCO® and DHASCO-S® (Martek Biosciences Corporation).

For example, U.S. Pat. No. 5,397,591 describes, inter alia, single cell edible oils (algae oils) (and methods for making the oils), which contain at least 70% triglycerides, which contain about 20-35% DHA and lack EPA, isolated from Crypthecodinium cohnii, generally containing more than 70% triglycerides, having 15-20% myristic acid; 20-25% palmitic acid; 10-15% oleic acid: 30-40% DHA and 0-10% other triglycerides. U.S. Pat. No. 5,407,957 describes, inter alia, algae oils (and methods for making the oils) derived from Crypthecodinium cohnii, generally containing greater than about 90% triglycerides, at least 35% DHA by weight (w/w), in one example, having 15-20 myristic acid, 20-25% palmitic acid, 10-15% oleic acid, 40-45% DHA, and 0-5% other oils. U.S. Pat. No. 5,492,938 describes, inter alia, single cell edible oils (and methods for making the oils) containing at least 70% triglycerides, which contain about 20-35% DHA and lack EPA, isolated from Crypthecodinium cohnii, in one example, containing more than 70% triglycerides, having 15-20% myristic acid; 20-25% palmitic acid; 10-15% oleic acid; 30-40% DHA; 0-10% other triglycerides. U.S. Pat. No. 5,711,983 describes, inter alia, single cell edible oils (and methods for making the oils) containing at least 70% triglycerides, which contain about 20-35% DHA and lack EPA, isolated from Crypthecodinium cohnii, in one example, containing more than 70% triglycerides, having 15-20% myristic acid; 20-25% palmitic acid; 10-15% oleic acid; 30-40% DHA and 0-10% other triglycerides.

Suitable microalgae oils include those disclosed, for example, in U.S. Pat. No. 6,977,166 and U.S. Publication Number US 2004/0072330. Exemplary of an algal oil that can be included in the compositions described herein is Martek DHA™-S (supplied by Martek Biosciences Corporation, Columbia, Md.), derived from the marine alga Schizochytrium sp., containing not less than 35% DHA. This algal oil additionally contains 16.1% (22:5 .omega.6) docosapentaenoic acid, 1.3% (20:5 .omega.3) eicosapentaenoic acid, 0.6% (20:4 .omega.6) arachidonic acid, 1.6% (18:2 .omega.6) linoleic acid, 16.9% (18:1 .omega.9) oleic acid and 19.8% other fatty acids. Also exemplary of an algal oil for the compositions described herein is Docosahexaenoic acid (supplied by VB Medicare Private Limited, Bangalore, Ind.), derived from the marine alga Schizochytrium sp., containing not less than 35% DHA. Any oil derived from dinoflagellate, for example, microalgae, which contains DHA, and optionally EPA, is suitable as an algae oil for use with the compositions described herein, for example, V-Pure algae oil (Water4Life, Switzerland), which contains EPA and DHA.

Artificial Sweetener: A sugar substitute is a food additive that duplicates the effect of sugar in taste, usually with less food energy. Some sugar substitutes are natural and some are synthetic. Those that are not natural are, in general, called artificial sweeteners.

An important class of sugar substitutes are known as high-intensity sweeteners. These are compounds with many times the sweetness of sucrose, common table sugar. As a result, much less sweetener is required and energy contribution is often negligible. The sensation of sweetness caused by these compounds (the “sweetness profile”) is sometimes notably different from sucrose, so they are often used in complex mixtures that achieve the most natural sweet sensation.

If the sucrose (or other sugar) that is replaced has contributed to the texture of the product, then a bulking agent is often also needed. This may be seen in soft drinks that are labeled as, e.g., “diet” or “light” and contain artificial sweeteners and often have notably different mouthfeel, or in table sugar replacements that mix maltodextrins with an intense sweetener to achieve satisfactory texture sensation.

In the United States, six intensely-sweet sugar substitutes have been approved for use. They are stevia, aspartame, sucralose, neotame, acesulfame potassium, and saccharin. There is some ongoing controversy over whether artificial sweetener usage poses health risks. The US Food and Drug Administration regulates artificial sweeteners as food additives. Food additives must be approved by the FDA, which publishes a Generally Recognized as Safe (GRAS) list of additives. To date, the FDA has not been presented with scientific information that would support a change in conclusions about the safety of these approved high-intensity sweeteners (with the exception of Stevia, which is exempt under FDA's GRAS policy due to its being a natural substance in wide use well before 1958, and has been approved by FDA). The safe conclusions are based on a detailed review of a large body of information, including hundreds of toxicological and clinical studies.

The majority of sugar substitutes approved for food use are artificially-synthesized compounds. However, some bulk natural sugar substitutes are known, including sorbitol and xylitol, which are found in berries, fruit, vegetables, and mushrooms. It is not commercially viable to extract these products from fruits and vegetables, so they are produced by catalytic hydrogenation of the appropriate reducing sugar. For example, xylose is converted to xylitol, lactose to lactitol, and glucose to sorbitol. Other natural substitutes are known, but are yet to gain official approval for food use.

Some non-sugar sweeteners are polyols, also known as “sugar alcohols”. These are, in general, less sweet than sucrose but have similar bulk properties and can be used in a wide range of food products. Sometimes the sweetness profile is ‘fine-tuned’ by mixing with high-intensity sweeteners. As with all food products, the development of a formulation to replace sucrose is a complex proprietary process.

### Borage Oil (Gamma-Linolenic Acid (GLA))

Suitable omega-6 containing non-polar compounds for the compositions described herein include compounds containing GLA, for example, borage oil. GLA is an omega-6 PUFA, which primarily is derived from vegetable oils, for example, evening primrose (Oenothera biennis) oil, blackcurrant seed oil, hemp seed oil, and spirulina extract. GLA has been used as a nutritional supplement. It has been proposed that GLA has a role in treating various chronic diseases and in particular that it has anti-inflammatory effects (Fan and Chapkin, The Journal of Nutrition (1998), 1411-1414). In one example, the non-polar active ingredient contains at least about 22% or about 22%, by weight (w/w), GLA, for example, at or about 22, 23, 24, 25, 26, 27, 28, 29, 30, 31, 32, 33, 34, 35, 36, 37, 38, 39, 40, 50, 60%, or more, by weight (w/w). GLA. Omega-6 containing non-polar active ingredients are typically added to the compositions in amounts such that when diluted in a food or beverage, one serving of the food or beverage provides an amount of the omega-6 fatty acid (e.g., GLA) between at or about 1.5 and at or about 3 g, typically between at or about 1.5 and at or about 2 g, between at or about 1.5 and at or about 2.5 g, between at or about 2 and at or about 2.5 g, between at or about 2 and at or about 3 g, between at or about 2.5 and at or about 3, for example, at or about 1.5, at or about 2, at or about 2.5 or at or about 3 g. per serving of the food or beverage, such as for example, 8 or 10 ounces of a beverage.

Beverage: As provided herein can be, for example, a water-based finished beverage, for example, juices, including fruit juice, energy drinks, sports drinks, nutritional beverages, vitamin-fortified beverages, milk, tea, cola, soda, flavored water and water.

### Carbonated Drinks (Sometimes Referred to as Soft Drinks)

In the late 18th century, scientists made important progress in replicating naturally carbonated mineral waters. In 1767, Englishman Joseph Priestley first discovered a method of infusing water with carbon dioxide to make carbonated water when he suspended a bowl of distilled water above a beer vat at a local brewery in Leeds, England. His invention of carbonated water (also known as soda water) is the major and defining component of most soft drinks.

Priestley found that water treated in this manner had a pleasant taste, and he offered it to friends as a refreshing drink. In 1772. Priestley published a paper entitled Impregnating Water with Fixed Air in which he describes dripping oil of vitriol (or sulfuric acid as it is now called) onto chalk to produce carbon dioxide gas, and encouraging the gas to dissolve into an agitated bowl of water.

Another Englishman, John Mervin Nooth, improved Priestley's design and sold his apparatus for commercial use in pharmacies. Swedish chemist Torbern Bergman invented a generating apparatus that made carbonated water from chalk by the use of sulfuric acid. Bergman's apparatus allowed imitation mineral water to be produced in large amounts. Swedish chemist Jöns Jacob Berzelius started to add flavors (spices, juices, and wine) to carbonated water in the late 18th century.

Clear: can be used to describe a composition as provided herein, for example, an aqueous liquid dilution composition containing the emulsion concentrates and/or the emulsion concentrates themselves. In one example, a clear liquid is one that does not appear cloudy by empirical observation (e.g., to the naked eye) and/or does not contain particles or crystals that are visible to the naked eye, or that does not exhibit “ringing.” In another example, a clear liquid is one that has a low or relatively low turbidity value, for example an NTU value, that is less than or equal to a desired NTU value. In one example, a clear liquid has an NTU value of less than 300 or less than about 300, typically less than 250 or less than about 250, typically less than 200 or less than about 200, for example, 200, 175, 150, 100, 50, 25 or less.

In another example, a liquid is clear if it has an NTU value of 30 or about 30; or an NTU value of less than 30 or less than about 30, for example, less than 29 or less than about 29, less than 28 or less than about 28, less than 27 or less than about 27, less than 26 or less than about 26, less than 25 or less than about 25, less than 24 or less than about 24, less than 23 or less than about 23, less than 22 or less than about 22, less than 21 or less than about 21, less than 20 or less than about 20, less than 19 or less than about 19, less than 18 or less than about 18, less than 17 or less than about 17, less than 16 or less than about 16, less than 15 or less than about 15, less than 14 or less than about 14, less than 13 or less than about 13, less than 12 or less than about 12, less than 11 or less than about 11, less than 10 or less than about 10, less than 9 or less than about 9, less than 8 or less than about 8, less than 7 or less than about 7, less than 6 or less than about 6, less than 5 or less than about 5, less than 4 or less than about 4, less than 3 or less than about 3, less than 2 or less than about 2, less than 1 or less than about 1; or 29 or about 29, 28 or about 28, 27 or about 27, 26 or about 26, 25 or about 25, 24 or about 24, 23 or about 23, 22 or about 22, 21 or about 21, 20 or about 20, 19 or about 19, 18 or about 18, 17 or about 17, 16 or about 16, 15 or about 15, 14 or about 14, 13 or about 13, 12 or about 12, 11 or about 11, 10 or about 10, 9 or about 9, 8 or about 8, 7 or about 7, 6 or about 6, 5 or about 5, 4 or about 4, 3 or about 3, 2 or about 2, 1 or about 1, or 0 or about 0. In another example, a clear liquid is one that has a small or relatively small average particle size (e.g., less than 1000 nm or less than about 1000 nm, typically less than 500 nm or less than about 500 nm, typically less than 300 nm or less than about 300 nm, typically less than 250 nm or less than about 250 nm, typically less than 200 nm or less than about 200 nm, for example, less than 150 or less than about 150 nm, less than 100 nm or less than about 100 nm, less than 75 nm or less than about 75 nm, less than 50 nm or less than about 50 nm, less than 25 nm or less than about 25 nm or less than 10 nm or less than about 10 nm), for example, less than or less than about 5, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 60, 70, 80, 90, 100, 110, 120, 130, 140, 150, 160, 170, 180, 190, or 200 nm.

In another example, clarity is expressed relatively. For example, it can be desired that a particular composition is equally as clear, about as clear, or more clear than another composition (as measured empirically, or by measuring turbidity value or particle size). For example, clarity can be assessed relative to another aqueous liquid dilution composition, for example, a beverage. In one example, a liquid is clear if it is similar in appearance to another clear liquid, for example, a beverage, for example, water. For example, it can be desired that a composition has particles having an average particle size that is less than or equal to that of particles in another liquid, for example, a beverage: In another example, it can be desired that a composition has a turbidity value that is less than or equal to another liquid, for example, a beverage.

DHA/EPA Exemplary of non-polar active ingredients that contain one or more omega-3 fatty acids, which can be used in the compositions described herein, are compounds containing DHA and/or EPA, for example, marine oil, for example, fish oil, krill oil and algae oil. Any oil containing DHA and/or EPA can be used. In one example, the non-polar active ingredient contains between 10% (or about 10%) and 40% (or about 40%) DHA. In another example, the non-polar active ingredient contains between 25% (or about 25%) and 35% (or about 35%) DHA. In another example, the non-polar active ingredient contains at least 70% (or about 70%), by weight (w/w), DHA, for example, at least 75% (or about 75%), at least 80% (or about 80%), at least 85% (or about 85%), or at least 90% or (about 90%), by weight (w/w), DHA. In another example, the non-polar active ingredient contains between 5% (or about 5%) and 20% (or about 20%) EPA, for example, at or about 5, 6, 7, 8, 9, 10, 11, 12, 13, 14, 15, 16, 17, 18, 19 or 20%, by weight (w/w), EPA.

In another example, the non-polar active ingredient contains not more than 10% (or about 10%) EPA or less than 10% (or about 10%) EPA. In another example, the non-polar active ingredient contains DHA and EPA, for example, DHA representing at least 20/o (or about 20%), by weight of the non-polar active ingredient and EPA representing not more than 13% (or about 13%) of the non-polar active ingredient, for example, not more than 10% (or about 10%), by weight of the non-polar active ingredient. In another example, the non-polar active ingredient contains DHA, representing at least 35% (or about 35%) of the non-polar active ingredient and EPA representing not more than 13% (or about 13%) of the non-polar active ingredient, for example, not more than 10% (or about 10%) of the non-polar active ingredient. In another example, the non-polar active ingredient contains DHA and EPA, for example, DHA representing at least 70% (or about 70%) of the non-polar active ingredient and EPA representing not more than 13% or about 13% of the non-polar active ingredient, for example, not more than 10% (or about 10%) of the non-polar active ingredient. In another example, the non-polar active ingredient contains DHA and EPA, for example, DHA representing at least 9% (or about 9%) of the non-polar active ingredient, for example, at least 11% (or about 11%) or the non-polar active ingredient and EPA representing at least 15% (or about 15%) of the non-polar active ingredient, for example, at least 17% (or about 17%) of the non-polar active ingredient. Omega-3 containing non-polar active ingredients are typically added to the compositions in amounts such that when diluted in a food or beverage, one serving of the food or beverage provides an amount of the omega-3 fatty acids (e.g., DHA and/or EPA) between at or about 16 mg and at or about 220 mg, typically between at or about 32 mg and at or about 220 mg, between at or about 50 mg and at or about 150 mg, between at or about 100 mg and at or about 220 mg, for example, at or about 16 mg, at or about 32 mg, at or about 50 mg, at or about 100 mg, at or about 150 mg, at or about 200 mg, or at or about 220 mg, per serving of the food or beverage, such as for example, 8 or 10 ounces(oz) of a beverage.

“Enhanced” shelf life: refers to a time period within which the compositions described herein remain stable, for example, under a non-refrigerated environment of over 70° Fahrenheit (F) that is being exposed to sun light. Such an environment can be that, by way of example only, inside of a store within the range of sunlight penetrating a window or door, outdoors, inside a vehicle having windows or a sunroof, for example, the ability of the compositions described herein to remain stable, i.e., free from one or more changes over a period of time. In one example, the compositions are stable if they exhibit one or more of these described characteristics, over time, when kept at a particular temperature. In one example, the compositions remain stable at room temperature, for example, 25° C. or about 25° C. In another example, the compositions remain stable at between 19° C. and 25° C. In another example, the compositions remain stable at refrigerated temperatures, for example, 4° C. or about 4° C., or at frozen temperature, for example, at −20° C. or about −20° C.

Emulsions: (e.g., oil-in-water emulsions) are colloidal dispersions of two immiscible liquids (e.g., oil and water or other aqueous liquid), containing a continuous and a dispersed phase. Emulsions can be used to disperse non-polar compounds in aqueous liquids. In an oil-in-water emulsion, the dispersed phase is an oil phase and the continuous phase is an aqueous (water) phase. There is a need for emulsions (e.g., oil-in-water emulsions) containing non-polar compounds in aqueous liquids and methods and compositions for generating the dilution compositions, such as food and beverages, that are stable and/or clear. In particular, emulsions are needed that are more suitable and desirable for human consumption of the non-polar compounds, for example, in foods and beverages. For example, emulsions having improved stability (e.g., lack of separation, flocculation, creaming), clarity (e.g., small average particle size, low turbidity), taste and smell, particularly when diluted into a food or beverage to provide suitable amount of non-polar compounds as described herein (e.g., a desired dosage of an active ingredient) are in need and are provided herein.

Emulsions that are provided contain the non-polar compounds dispersed in aqueous liquid and have desirable properties, including improved stability, clarity, smell and taste. The compositions described herein (and methods for making the compositions) can be used to formulate any non-polar compound in water-based food and beverage compositions, including the non-polar compounds (e.g., non-polar active ingredients) described herein and other known non-polar compounds.

In some embodiments, the compositions described herein containing the non-polar compounds (e.g., as described herein) include emulsions having dispersed droplets (particles) with average diameters less than 1000 nm or less than about 1000 nm, typically, less than 500 nm or less than about 500 nm, typically less than 300 nm or less than about 300 nm, typically less than 250 or less than about 250 nm, typically less than 200 nm or less than about 200 nm, for example, less than or less than about 5, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 60, 70, 80, 90, 100, 110, 120, 130, 140, 150, 160, 170, 180, 190, or 200 nm. Typically, the provided emulsion compositions are oil-in-water emulsions, containing the non-polar compounds dispersed in aqueous liquid.

The provided emulsion compositions can be stabilized by one or more surfactants and/or co-surfactants. In some embodiments, the emulsion composition described herein can also include more than 1% or more than about 1%, and up to and including 3%, 4%, 5%, 6%, 7%, 8%, 9%, 10%, 12%, 13%, 14%, and 15%, of an emulsion stabilizer. In some embodiments, the emulsion stabilizer is a fatty acid-modified carbohydrate-based macromolecule emulsion stabilizer. The fatty acid-modified carbohydrate-based macromolecules include modified gums and starches or other such suitable carbohydrate-based macromolecules. In some embodiments, gums and starches or other such suitable carbohydrate-based macromolecules are modified by esterification with a fatty acid anhydride, such as an n-octenyl succinic anhydride. Such modified gums and starches act as a co-emulsifier to a surfactant, such as the SFAE, in the compositions provided herein, wherein the resulting solution can include high concentrations (up to 50% or up to at least about 50% or at least 50%) of a non-polar compound into the concentrate. In one example, the fatty acid modified carbohydrate is a modified starch, for example, a modified corn starch obtained through the chemical conversion of a waxy corn starch, such as by modification with an n-octenyl succinic anhydride (OSAn-). Exemplary of an OSAn-modified corn starch is a calcium starch octenyl succinate, sold under the name Farmal® MS 6135, from Corn Products International Inc., Westchester, Ill., available from Cosmetic Specialties, Inc., Haddon Heights, N.J. Modified corn starches and processes for their preparation are disclosed in U.S. Pat. No. 2,661,349.

In another example, the fatty acid-modified carbohydrate is a modified gum acacia, for example, gum acacia, or gum arabic, modified by reaction with a cyclic anhydride, especially a cyclic anhydride that contains a substituent group containing 5 to 18 carbon atoms, such as 1-octenylsuccinic anhydride (OSAn), resulting in gum acacia derivatives with balanced lipophilic and hydrophilic properties, i.e., “lipophilic gum acacia”. Suitable modified gum acacia includes for example, the modified gum acacia sold under the name Tic Pretested® Ticamulsion A-2010 Powder, by Tic Gums, Inc., Belcamp, Md., which has a reported degree of esterification that is not more than 0.6%. Modified gum acacia and processes for its preparation are disclosed in U.S. Pat. No. 6,455,512, which describes a hydrocolloid system containing the modified gum acacia.

Surfactants can form an interfacial film in the emulsion, between the oil and water phase, providing stability. In some embodiments, the emulsions of the compositions described herein contain micelles, in which one or more surfactant(s) surround the non-polar active compound.

The provided emulsion compositions include liquid emulsion concentrates containing the non-polar compounds (e.g., as described herein), which can be diluted to provide non-polar compounds, for example, in water-based finished foods and beverages. The liquid emulsion concentrates can be diluted into a medium, for example, an aqueous medium, for example, a beverage (e.g., a carbonated beverage as described herein), to form a liquid dilution composition (e.g., aqueous liquid dilution composition) containing the non-polar compound. Alternatively, the liquid emulsion concentrate can be diluted into a food, for example, a tomato-paste based product, a dairy-based product, a sauce, a cream, a soup or a dressing, to form a dilution composition containing the non-polar compound. Also exemplary of the compositions described herein are the dilution compositions (e.g., food or beverage dilution compositions, which can be stable) made by diluting the liquid emulsion concentrates in the food or beverage.

The compositions herein can be made using any non-polar compound, e.g., those known in the art. The non-polar compounds can be non-polar active ingredients, for example, pharmaceuticals, nutraceuticals, vitamins and minerals. The non-polar active ingredients include, but are not limited to, unsaturated fatty acids, including polyunsaturated fatty acid (PUFA)-containing compounds, for example, omega-3-containing active ingredients, for example, compounds containing ALA, DHA and/or EPA, for example, oils derived from fish and microalgae, krill and/or flaxseed extract, and omega-6-containing non-polar active ingredients, for example, gamma-linolenic acid (GLA)-containing compounds, for example, borage oil; omega-9 containing non-polar active ingredients, for example, oleic acid; saw palmetto oil-containing compounds; conjugated fatty acid containing-ingredients, for example, conjugated linoleic acid (CLA)-containing compounds; coenzyme Q-containing active ingredients, for example, Coenzyme Q10 (CoQ10), typically oxidized CoQ10 (ubidecarenone)-containing compounds; phytochemical-containing compounds, for example, phytosterols (plant sterols), resveratrol, and carotenoids, for example, lycopene, lutein and zeaxanthin; fat-soluble vitamins, for example, Vitamin A palmitate and vitamin D3; and alpha lipoic acid (thioctic acid). Additional exemplary non-polar active ingredients are described herein. In some embodiments, the compositions provided herein include at least one non-polar compound (e.g., as described herein). In some embodiments, the compositions provided herein include one non-polar compound (e.g., as described herein). In some embodiments, the compositions provided herein include more than one non-polar compound (e.g., as described herein).

Essential fatty acids: are fatty acids including PUFAs that mammals, including humans, cannot synthesize internally. Thus, essential fatty acids must be obtained externally, e.g., from diet or by supplementation. Exemplary of essential PUFA fatty acids are omega-3 (.omega.3; n-3) fatty acids and omega-6 (.omega.-6; n-6) fatty acids.

Fatty Acid: refers to straight-chain hydrocarbon molecules with a carboxyl (COOH) group at one end of the chain. In any of the embodiments described herein, the fatty acids can be provided as free carboxylic acids, triglycerides, monoglycerides, diglycerides, esters (e.g., methyl or ethyl esters), or other forms known in the art.

Fish Oil refers to any oil derived from any fish, typically a cold water fish, for example, from fish tissue, for example, from frozen fish tissue, for example, from cod liver. In one example, fish oil is used as a non-polar compound, for example, an active ingredient, in the compositions described herein. The fish oil typically contains DHA. In one example, the fish oil also contains EPA.

Also suitable non-polar compounds containing Omega-3 PUFAs, particularly DHA (and optionally EPA), that can be used as the non-polar compound in the compositions described herein include oils derived from microorganisms, for example, oils derived from marine dinoflagellates, for example, microalgae, for example, Crypthecodinium sp, particularly, Crypthecodinium cohnii. Microalgae oils, like algal oil, are an excellent source of omega-3 fatty acids, particularly DHA (see e.g., U.S. Pat. Nos. 5,397,591, 5,407,957, 5,492,938 and 5,711,983). Suitable oils derived from microalgae are the oils disclosed in, and oils made according to the methods described in. U.S. Pat. Nos. 5,397,591, 5,407,957, 5,492,938 and 5,711,983 and U.S. Publication number 2007/0166411, including DHASCO® and DHASCO-S® (Martek Biosciences Corporation).

For example, U.S. Pat. No. 5,397,591 describes, inter alia, single cell edible oils (algae oils) (and methods for making the oils), which contain at least 70% triglycerides, which contain about 20-35% DHA and lack EPA, isolated from Crypthecodinium cohnii, generally containing more than 70% triglycerides, having 15-20% myristic acid; 20-25% palmitic acid; 10-15% oleic acid; 30-40% DHA and 0-10% other triglycerides. U.S. Pat. No. 5,407,957 describes, inter alia, algae oils (and methods for making the oils) derived from Crypthecodinium cohnii, generally containing greater than about 90% triglycerides, at least 35% DHA by weight (w/w), in one example, having 15-20 myristic acid, 20-25% palmitic acid, 10-15% oleic acid, 40-45% DHA, and 0-5% other oils. U.S. Pat. No. 5,492,938 describes, inter alia, single cell edible oils (and methods for making the oils) containing at least 70% triglycerides, which contain about 20-35% DHA and lack EPA, isolated from Crypthecodinium cohnii, in one example, containing more than 70% triglycerides, having 15-20% myristic acid; 20-25% palmitic acid; 10-15% oleic acid; 30-40% DHA; 0-10% other triglycerides. U.S. Pat. No. 5,711,983 describes, inter alia, single cell edible oils (and methods for making the oils) containing at least 70% triglycerides, which contain about 20-35% DHA and lack EPA, isolated from Crypthecodinium cohnii, in one example, containing more than 70% triglycerides, having 15-20% myristic acid; 20-25% palmitic acid; 10-15% oleic acid; 30-40% DHA and 0-10% other triglycerides.

Also suitable microalgae oils include those disclosed, for example, in U.S. Pat. No. 6,977,166 and U.S. Publication Number US 2004/0072330. Suitable algal oil that can be included in the compositions described herein includes Martek DHA™-S (supplied by Martek Biosciences Corporation, Columbia, Md.), derived from the marine alga Schizochytrium sp., containing not less than 35% DHA. This algal oil additionally contains 16.1% (22:5 .omega.6) docosapentaenoic acid, 1.3% (20:5 .omega.3) eicosapentaenoic acid, 0.6% (20:4 .omega.6) arachidonic acid, 1.6% (18:2 .omega.6) linoleic acid, 16.9% (18:1 .omega.9) oleic acid and 19.8% other fatty acids. Suitable algal oil that can be included in the compositions described herein also includes Docosahexaenoic acid (supplied by VB Medicare Private Limited, Bangalore, Ind.), derived from the marine alga Schizochytrium sp., containing not less than 35% DHA. Any oil derived from dinoflagellate, for example, microalgae, which contains DHA, and optionally EPA, is suitable as an algae oil for use with the compositions described herein, for example, V-Pure algae oil (Water4Life, Switzerland), which contains EPA and DHA.

Suitable the PUFA-containing non-polar active ingredients that can be used in the compositions described herein include oils derived from fish, which contain DHA, EPA or DHA and EPA. Particularly, cold water marine fish are a known source of Omega-3 fatty acids (U.S. Pat. No. 4,670,285). Suitable fish oil containing DHA, EPA or DHA and EPA can be obtained from any commercial sources, for example, fish oils available from Hormel Foods Specialty Products, any of which can be used with the compositions described herein.

Fish oils typically are extracted from fish tissue, for example, frozen fish tissue. In one example, the fish oil is a tasteless fish oil, for example, a cod liver oil, which has been isolated from fish, for example, from cod liver, and then refined and deodorized, or in some other way treated so its taste becomes neutral, for example, as described in International Publication Nos. WO 00/23545 and WO 2004/098311. In one example, these fish oils are isolated from frozen fish tissue by a process that minimizes oxidation. Exemplary of such a tasteless fish oil is Denomega™ 100, Borregaard Ingredients, Sarpsborg, Norway; distributed by Denomega Nutritional Oils AS, Boulder, Colo. Typically, the tasteless fish oil, for example, cod liver oil, contains between 25% (or about 25%) and 35% (or about 35%) Omega-3 fatty acids, for example, 34% Omega-3 fatty acids. In one example, the fish oil, for example, the Denomega™ 100 oil, contains 13% (or about 13%) DHA and 13% (or about 13%) EPA.

Also, exemplary of the fish oils that can be included in the compositions described herein are fish oils containing high amounts of Omega-3 fatty acids, for example, high amounts of DHA. One example of such a fish oil contains at least about 85% DHA, typically greater than 85% DHA and at least about 90/o Omega-3 fatty acids, typically greater than, 90% Omega-3 fatty acids. In another example, the fish oil can contain 98% PUFA, including 89% Omega-3 fatty acids, about 70% DHA, about 10% EPA, 8.9% Omega-6 fatty acids and 0.7% Omega-9 fatty acids. Exemplary of a fish oil containing high amounts of Omega-3 fatty acids that can used as the non-polar compound in the compositions described herein is an Omega-3 Fish Oil EE (O3C Nutraceuticals, supplied by Jedwards International Inc., Quincy. Mass.), which contains 89% Omega-3 fatty acids, 8.9% Omega-6 fatty acids, 0.7% Omega-9 fatty acids, 0.1% saturated fatty acids, 1.0% monounsaturated fatty acids, 74.5% Docosahexanoic (DHA) fatty acids, 9.3% Eicosapentaenoic (EPA) fatty acids and 98% polyunsaturated fatty acids (PUFA). This fish oil also contains 0.1% (16:0) palmitic acid, 0.1% (16:1.omega.7) palmitoleic acid, 0.1% (18:0) stearic acid, 0.6% (18:1 .omega.9) oleic acid, 0.1% (18:1 w 7) oleic acid, 0.3% (18:2.omega.6) linoleic acid, 0.2% (18:3 .omega.3) linolenic acid, 0.2% (18:4 .omega.3) octadecatetraenoic acid, 0.1% (20:1 .omega.9) eicosanoic acid, 0.1% (20:2 .omega.6) eicosadienoic acid, 0.2% (20:3 .omega.6) Eicosatrienoic Acid, 2.4% (20:4 .omega.6) arachidonic acid, 0.6% (20:4 .omega.3) arachidonic acid, 0.1% (22:1 .omega.11) erucic acid, 0.6% (21:5 .omega.3) uncosapentaenoic acid, 0.5% (22:4 .omega.6) docosatetraenoic acid, 5.4% (22:5 .omega.6), docosapentaenoic acid, 3.6% (22:5 .omega.3) docosapentaenoic acid and 0.9% other fatty acids.

Also, exemplary of a fish oil containing high amounts of Omega-3 fatty acids that can be used in the compositions described herein is Omega Concentrate 85 DHA TG Ultra (O3C Nutraceuticals AS, Oslo, Norway), which contains greater than 85% DHA (C22:6n-3) and greater than 90% total omega-3 fatty acids and is isolated from fatty fish species Eugraulidae, Clupeidae and Scombridae families. This fish oil is produced by purifying and concentrating the oils from these fish with known technologies to increase the concentration of omega-3 fatty acid DHA.

Any fish oil containing DHA and/or EPA can be used as the non-polar compound in the compositions described herein. Exemplary of the fish oils that can be included in the compositions described herein is Eterna™ Omegasource™ Oil (supplied by Hormel Foods Specialty Products Division, Austin, Minn.), which contains at least 30% Omega-3 fatty acids (DHA. EPA and ALA), is odorless, virtually free of cholesterol and bland in flavor. This fish oil contains about 28% DHA and EPA, typically 17% EPA and 11% DHA, and additionally contains 4.5% Omega-6 fatty acids. Also exemplary of the fish oils that can be included in the compositions described herein are Omega 30 TG Food Grade (Non-GMO) MEG-3™ Fish Oil (supplied by Ocean Nutrition Canada, Dartmouth, Nova Scotia, Canada), a Kosher fish oil which contains about 30% DHA/EPA and Marinol C-38 (supplied by Lipid Nutrition B.V., Channahon, Ill.), which contains about 52% omega-3 fatty acids, including at least 38% DHA/EPA, more specifically includes about 22% EPA and 14% DHA. Also suitable fish oils include other fish oils made by O3C Nutraceuticals, AS and other fish oils supplied by Jedwards, International, Inc. Also exemplary of a fish oil is Marinol D-40 (supplied by Lipid Nutrition B.V., Channahon, Ill.), which contains about 40% DHA and 7% EPA.

Also suitable fish oils include Krill oils, made according to International Publication No. WO 2007/080515.

Flavor: is any ingredient that changes, typically improves, the taste and/or smell of the compositions described herein, for example, the aqueous liquid dilution compositions, for example, beverages (e.g., carbonated beverages). In one example, the compositions provided herein further contains one or more flavors or flavoring agents, for example, any compound to add flavor to the concentrate and/or to the aqueous liquid dilution composition containing the diluted concentrate, for example, the food or beverage containing the concentrate. Any known flavors can be added to the concentrates, for example, any flavor sold by Mission Flavors, Foothill Ranch, Calif. Suitable flavors that can be used include fruit flavors, such as guava, kiwi, peach, mango, papaya, pineapple, banana, strawberry, raspberry, blueberry, orange, grapefruit, tangerine, lemon, lime and lemon-lime; cola flavors, tea flavors, coffee flavors, chocolate flavors, dairy flavors, root beer and birch beer flavors, methyl salicylate (wintergreen oil, sweet birch oil), citrus oils and other flavors. Typically, the flavors are safe and/or desirable for human consumption, for example, GRAS or Kosher-certified flavors. Suitable flavoring agents that can be used in the compositions include lemon oil, for example lemon oil sold by Mission Flavors. Foothill Ranch, Calif.; and D-limonene, for example, 99% GRAS certified D-Limonene, sold by Florida Chemical, Winter Haven, Fla. In some embodiments, the flavor is added, using the provided methods, to the emulsion concentrates after combining the oil and water phases. In some embodiments, flavor(s) can be added to the water and/or oil phase directly. In some embodiments, the compositions provided herein include at least one flavor (e.g., as described herein). In some embodiments, the compositions provided herein include one flavor (e.g., as described herein). In some embodiments, the compositions provided herein include more than one flavor (e.g., as described herein).

The concentration of flavoring agent added to the compositions described herein (e.g., the concentrates or the diluted food or beverage) can be less than 5% or less than about 5%, typically less than 1% or less than about 1%, for example, 0.1%, 0.2%, 0.3%, 0.4%, 0.5%, 0.6%, 0.7%, 0.8% or 0.9%.

Flax Seed Oil—Omega 3 (ALA) Also exemplary of the Omega-3 containing non-polar compounds used in the compositions described herein is flaxseed oil (flaxseed oil, linseed oil). Flaxseed oils, which are good sources of omega-3 fatty acids, particularly alpha-linolenic acid, have been used as nutritional supplements. Flaxseed oils are produced by pressing the flax seed and refining the oil from the flax seeds. Exemplary of a flaxseed oil that can be used as the non-polar compound in the compositions described herein is flaxseed oil derived from Linum usitatissimum L., for example, flaxseed oil supplied by Sanmark LLC, Greensboro, N.C. (Sanmark Limited, Dalian. Liaoning Province, China), which contains not less than (NLT) 50% C18:3 alpha-linolenic acid, and further contains other fatty acids, for example, 3-8% C16:0 Palmitic acid, 2-8% C18:0 Stearic acid, 11-24% C18:1 Oleic acid, 11-24% C18:2 linoleic acid and 0-3% other fatty acids. Also suitable flaxseed oil includes a flaxseed oil containing 6% Palmitic acid, 2.5% stearic acid, 0.5% arachidic acid, 19% oleic acid, 24.1% linoleic acid, 47.4% linolenic acid, and 0.5% other fatty acids. Also exemplary flaxseed oil that can be used as the non-polar compound in the compositions described herein is Barlean's Organic Flaxseed Oil (supplied by Barlean's Organic Oils. Ferndale, Wash.), containing not less than 55% alpha-linolenic acid, and further contains other fatty acids, for example, 5.5% C16:0 Palmitic acid, 5% C18:0 Stearic acid, 17% C18:1 Oleic acid, 17% C18:2 linoleic acid and 0-1% other fatty acids. The fatty acid composition of flaxseed oil can vary. Any flaxseed oil can be used as the non-polar compound in the compositions described herein. In one example, the flaxseed oil contains at least 45% alpha-linolenic acid or at least about 45% alpha-linolenic acid. In another example, the flaxseed oil contains at least 65% or at least about 65%, or at least 70% or at least about 70% alpha-linolenic acid. Exemplary of a flaxseed containing greater than 65% linolenic acid content (of total fatty acid content), for example, 70-80% or 70-75%, is the flaxseed described in U.S. Pat. No. 6,870,077.

Fructose: (fruit sugar), is a simple monosaccharide found in many plants. It is one of the three dietary monosaccharides, along with glucose and galactose, that are absorbed directly into the bloodstream during digestion. Fructose was discovered by French chemist Augustin-Pierre Dubrunfaut in 1847. Pure, dry fructose is a very sweet, white, odorless, crystalline solid and is the most water-soluble of all the sugars. From plant sources, fructose is found in honey, tree and vine fruits, flowers, berries, and most root vegetables. In plants, fructose may be present as the monosaccharide and/or as a molecular component of sucrose, which is a disaccharide.

Commercially, fructose frequently is derived from sugar cane, sugar beets, and corn and there are three commercially important forms. Crystalline fructose is the monosaccharide, dried, ground, and of high purity. The second form, high-fructose corn syrup (HFCS) is a mixture of glucose and fructose as monosaccharides. The third form, sucrose, is a compound with one molecule of glucose covalently linked to one molecule of fructose. All forms of fructose, including fruits and juices, are commonly added to foods and drinks for palatability and taste enhancement, and for browning of some foods, such as baked goods. About 240,000 tons of crystalline fructose are produced annually.

Fructose is a 6-carbon polyhydroxyketone. It is an isomer of glucose; i.e., both have the same molecular formula (C6H12O6) but they differ structurally. Crystalline fructose adopts a cyclic six-membered structure owing to the stability of its hemiketal and internal hydrogen-bonding. This form is formally called D-fructopyranose. In solution, fructose exists as an equilibrium mixture of 70% fructopyranose and about 22% fructofuranose, as well as small amounts of three other forms, including the acyclic structure.

High Glycemic: High glycemic foods have a Glycemic Index (“GI”) of 60 or above and are applied only to carbohydrates. Foods that fall into this category are usually processed foods that contain high amounts of sugar, white flour products and artificial sweeteners.

High glycemic foods cause a rapid rise in blood sugar because they are digested very quickly. They may trigger several reactions and health problems including increased heart rate, high blood pressure, inflammation, allergies, fatigue or an energy crash shortly after consumption. People who are suffer from acne and other inflammatory skin conditions can aggravate their symptoms after eating high-GI foods. A prevalence of high-glycemic foods in the diet can also stimulate fat storage, trigger hyperactivity and reduce the ability to concentrate.

Hydrocolloid: refers to water-soluble gums, including starches, gums, celluloses, modified celluloses, carboxymethyl cellulose, dextrans, dextrins, inulin, glycogen, hemicellulose, gum arabic, agar, karaya gum, tragacanth gum, pectin, carrageenan, alginates, tamarind seed gum, xanthan gum, konjac gum, guar gum, gum acacia, and locust bean (or carob seed) gum. These water-soluble gums can be reacted with an alkane- or alkene-substituted dicarboxylic acid anhydride to produce a fatty acid-modified carbohydrate-based emulsion stabilizer.

Liposomes: are surfactant aggregates composed of lipid bilayers, typically having an aqueous core. Liposomes typically are formed by lipid surfactants, typically, phospholipids, which are amphipathic, phosphate-containing lipids, for example, molecules containing one phosphate, a glycerol and one or more fatty acids, and similar surfactants. Alternatively, phospholipid surfactants can be used as co-surfactants, which can be incorporated into aggregates of other surfactant(s), for example, micelles. Lipid bilayers are two dimensional sheets in which all of the hydrophobic portions, e.g., acyl side chains, are shielded from interaction with aqueous liquid, except those at the ends of the sheet. An energetically unfavorable interaction of the acyl chains with water results in the folding of the bilayers to form liposomes, three-dimensional lipid bilayer vesicles. In one example, the liposome is formed as a single bilayer enclosing a single aqueous space (small unilamellar vesicles: SUVS). In another example, the liposome is composed of concentric bilayers with many aqueous spaces alternating with the bilayers (multilamellar vesicles; MLVS).

Liposomes can be used to encapsulate hydrophobic and hydrophilic active ingredients. In liposomes, non-polar active ingredients typically are partitioned within the bilayers whereas hydrophilic active ingredients typically are trapped within the aqueous compartments. In one example, liposomes can be advantageous as a carrier/encapsulation system because they are stable and can protect the active ingredients from degradation, e.g., by oxygen and digestive enzymes.

Liquid Emulsion Concentrates: Containing the Non-Polar Compounds provided are liquid emulsion concentrates (also called “concentrates” or “liquid concentrates”) containing one or more non-polar compounds (non-polar active ingredients), e.g., those as described herein. The concentrates can be diluted into food or beverages (e.g., carbonated beverages) to form dilution compositions containing the non-polar compounds. The liquid concentrates are formulated based on one or more desirable properties, for example, stability, for example, lack of phase separation, flocculation, creaming, “ringing” and/or precipitation over time; clarity; safety; taste; smell; and/or bioavailability of the concentrate and/or the dilution compositions containing the concentrate. In one example, the desirable property is stability, such that when the provided concentrate is diluted into a food or beverage, the composition is stable, for example, free from separation, precipitation, flocculation, creaming and/or degradation of the non-polar compound. In another example, the desirable property includes the ability of the provided concentrate to yield a clear or partially clear aqueous liquid dilution composition when it is diluted into aqueous medium, for example, a beverage such as water or a carbonated beverage. In another example, the desirable property relates to the safety of the concentrates and/or the desirability of the concentrates for human consumption, for example, in foods and beverages (e.g., carbonated beverages). In another example, it can be desirable that the concentrate provides an effective amount of the non-polar active compound, including a recommended amount known for the non-polar active compound. In another example, it can be desirable that the concentrate contains less than or equal to a particular concentration of one or more ingredients. In another example, it can be desirable that the concentrate contains greater than or equal to a particular concentration of one or more ingredients.

In addition to the non-polar compounds, the concentrates can contain at least one surfactant. Suitable surfactants include those having an HLB value between 13 (or about 13) and 20 (or about 20), more typically between 15 (or about 15) and 18 (or about 18), for example, 13, 14, 15, 16, 17, 18, 19, 20, about 13, about 14, about 15, about 16, about 17, about 18, about 19 or about 20. Suitable surfactants include sugar ester surfactants, such as sucrose fatty acid ester (SFAE) surfactants, vitamin E derived surfactants containing a polyethylene glycol (PEG) moiety, such as tocopherol polyethylene glycol succinate (TPGS), and PEG-derived surfactants, such as PEG-sorbitan fatty acid esters, such as polysorbate 80. In some embodiments, the surfactant is a natural surfactant, for example, a surfactant that is GRAS (generally recognized as safe) certified by the FDA and/or Kosher certified.

The liquid concentrates can further contain at least one polar solvent, such as water (e.g., filtered water), or other edible aqueous liquid (e.g., propylene glycol or glycerin), or combination thereof.

The liquid concentrates can further contain at least one emulsion stabilizer in addition to the surfactants. Suitable emulsion stabilizers include a fatty acid-modified carbohydrate-based macromolecule, such as an n-octenyl succinic anhydride modified gum arabic, for example, the modified gum acacia sold under the name Tic Pretested® Ticamulsion A-2010 Powder, by Tic Gums, Inc., Belcamp, Md.

In some embodiments, the concentrates can further contain one or more additional ingredients. Exemplary of additional ingredients that can be included in the concentrates are soluble fiber, preservatives, non-polar solvents, co-surfactants, emulsion stabilizers, pH adjusters and flavoring agents.

The non-polar compounds in the concentrates and dilution compositions can be contained in micelles. These micelles, containing the non-polar compound surrounded by the one or more surfactants, allow dispersion of the non-polar compound among polar solvents, for example, when the concentrates are diluted to form dilution compositions. Suitable micelles containing the non-polar compounds include those have a small or relatively small average particle size, for example, less than 1000 nm or less than about 1000 nm, less than 500 nm or less than about 500 nm, typically less than 300 nm or less than about 300 nm, typically less than 200 nm or less than about 200 nm, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95, 100, 125, 150 or 200 nm. Smaller average particle size correlates with clarity of the liquid dilution compositions containing the concentrates. For example, a liquid with a smaller average particle size is clearer than a liquid with a larger average particle size. Small average particle size also can contribute to other desirable properties, for example, stability.

A number of factors, including ingredients, their relative concentrations, and methods for making the concentrates, can affect the average particle size of the compositions, and other desirable properties of the compositions, such as stability. For example, the nature of the surfactant, particularly the HLB of the surfactant, and the relative concentrations of polar solvent (e.g., water), surfactant, emulsion stabilizer and the non-polar compound, can contribute to small average particle size, and the stability of the dilution compositions. Typically, several of these parameters and properties can be related to one another. For example, several of the parameters contribute to the average particle size, typically small average particle size, of the compositions. Particle size can contribute directly to clarity of liquid dilution compositions, e.g., beverages (e.g., carbonated beverages), containing the concentrates. Particle size also can relate to other properties, for example, stability, lack of “ringing” and/or precipitate formation of food or beverage compositions containing the concentrates.

Accordingly, properties of the ingredients and their relative concentrations in the concentrates can be important for the ability of the concentrate to yield desirable dilution compositions. Thus, certain aspects of the present application provides methods for formulating the liquid emulsion concentrates. Determining the appropriate ingredients, and relative concentrations thereof, that will yield dilution compositions having desirable properties, is performed using provided methods for formulating the liquid concentrates.

Liquid Concentrates Formulation; in the provided formulation methods, the concentrates can be formulated by selecting ingredients and concentration ratios of the ingredients that yield compositions having one or more desired properties. When formulating the concentrates, selected ingredients and starting concentrations are used to make initial concentrates, which can be evaluated and modified, if necessary.

In some embodiments, as a first step in formulating the provided concentrates, one or more initial concentrates are made and evaluated for desired properties. For this step, ingredients are selected, for example, from among the ingredients described herein. The ingredients can include surfactants, polar solvents, non-polar active ingredients, emulsion stabilizers and other ingredients. A starting concentration (weight percentage) of each selected ingredient can be selected from within the appropriate concentration range for that ingredient or category of ingredient, for example, the appropriate concentration range for the surfactant. In some cases, the initial concentrate is formulated based on the ingredients, and concentrations thereof, of an existing concentrate, having one or more desired properties. In other cases, the initial concentrate is formulated based on providing a particular amount of a non-polar active ingredient, such that upon dilution of the concentrate in a food or beverage, a serving of the food or beverage provides a specific amount of non-polar active ingredient. For example, the initial concentrates provided herein can be formulated such that upon dilution in a food or beverage, the food or beverage contains between at or about 1.5 grams (g) to at or about 3.0 g of omega-6 fatty acids per serving, between at or about 16 milligrams (mg) to at or about 220 mg, for example, between at or about 32 mg to at our about 220 mg docosahexaenoic acid (DHA) and eicosapentaenoic acid (EPA) per serving, between at or about 100 mg and at or about 500 mg phytosterols per serving, between at or about 10 mg and at or about 200 mg, for example, between at or about 50 mg and at or about 200 mg Coenzyme Q10 per serving, between at or about 40 micrograms and at or about 400 micrograms (mcg)

Vitamin A per serving, or between at or about 400 international units (IU) and at or about 800 IU per serving, for example, per a serving of a food or beverage, for example, per 8 or 10 ounces of a beverage (e.g., a carbonated beverage as described herein).

The initial concentrate(s) then is made by using e.g., the methods for making the concentrates provided below by adding each ingredient at its starting concentration at the appropriate step. In one example, more than one initial concentrate, e.g., multiple initial concentrates, each having a different concentration of one or more ingredients, is made, and compared. In one example, multiple initial concentrates are produced to test various representative concentrations within an appropriate concentration range for one or more particular ingredient. In a typical example, the initial concentrate is made by including at least one surfactant, such as from among the surfactants described herein, that has an HLB value between 13 (or about 13) and 20 (or about 20), at a starting concentration within the concentration range of between 3% (or about 3%) and 16% (or about 16%), and typically between at or about 6% and at about 14%, by weight (w/w), of the concentrate; at least one non-polar compound, at a starting concentration within the concentration range of between 15% (or about 15%) and 50% (or about 50%), and typically between at or about 20% and at or about 50%; a polar solvent, at a starting concentration of between 30% (or about 30%) and 70% (or about 70%), and typically between at or about 40% and at or about 60%, by weight; and an emulsion stabilizer, at a starting concentration between 0.1% (or about 0.1%) and 10% (or about 10%), and typically between at or about 1% and at or about 3%. In one example, the initial concentrate further includes other ingredients, for example, soluble fiber(s), preservative(s), co-surfactant(s), and/or other ingredients as described herein.

In some embodiments, after making the initial concentrate(s), the concentrate(s) is evaluated for one or more desired properties, for example, the ability to form dilution compositions (e.g., stable dilution compositions or dilution compositions having a particular desired property, such as lack of flocculation). The ability to form dilution compositions having one or more properties can be determined by diluting the concentrate in a water-based finished food or beverage, for example, diluting the concentrate in the food or beverage at a dilution factor of between 1:10 (or about 1:10) and at most 1:1000 (or about 1:1000), typically between 1:10 (or about 1:10) and 1:500 (or about 1:500), for example, at a dilution between 1:10 (or about 1:10) and up to 1:250 (or about 1:250), for example, diluted between 1:10 (or about 1:10), 1:20 (or about 1:20), 1:25 (or about 1:25), 1:50 (or about 1:50), 1:100 (or about 1:100), 1:200 (or about 1:200), 1:250 (or about 1:250), or up to 1:500 (or about 1:500), for example, 1:10, 1:20, 1:25, 1:30, 1:35, 1:40, 1:50, 1:55, 1:60, 1:65, 1:70, 1:75, 1:80, 1:85, 1:90, 1:95, 1:100, 1:110, 1:120, 1:130, 1:140, 1:150, 1:160, 1:170, 1:180, 1:190, 1:200, 1:210, 1:220, 1:230, 1:240, 1:250, 1:260, 1:270, 1:280, 1:290, 1:300, 1:350, 1:400, 1:500, or according to other dilutions provided herein, and assessing the stability, presence of flocculation or creaming, “ringing” or forming of precipitates, clarity, turbidity value, particle size, color, smell, taste, safety or other desired property of the resulting dilution composition.

In some embodiments, after evaluation, the ingredients, and/or concentrations thereof, can be adjusted in order to generate the desired properties in the final concentrate. For example, the concentration of the non-polar compound, the surfactant, and/or the polar solvent can be adjusted after evaluating the initial concentrate. Similarly, when formulating multiple initial concentrates, one or more of the non-polar compound, surfactant and polar solvent concentration is/are varied among the multiple initial concentrates. In some cases, following evaluation, it can be determined that additional ingredients (not included in the initial formulation) are needed or desirable for achieving the desired properties of a particular concentrate. In some embodiments, this process can be repeated until a concentrate having the desired property or properties is generated.

Low Glycemic: A diet based on foods with low glycemic response has been associated with diabetes management, improved blood lipids (cholesterol), reduced risk of heart disease, and weight management. Not only will foods with a low glycemic index (e.g., with a GI of 55 or less) take longer to digest (therefore prolonging satiety) they will also maintain blood glucose levels at a relatively constant state. Foods with a high glycemic index not only digest quickly, they can cause extreme fluctuations in blood glucose.

There are some specific factors to look for in foods that can indicate their glycemic index: Low glycemic foods contain for example: Fat, Whole grains, Protein, Raw Starches, legumes, vegetables, fruits and dairy products. High Glycemic Foods contain for example: Refined grains, refined sugars, increased amylopectin:amylose ratio, and often high sugar fruits have a high glycemic index.

There are other factors that contribute to a foods glycemic index, such as plant variety, food processing, cooking method and whether the food is eaten by itself or in combination with other foods. There are criticisms of the glycemic index, including how impractical it is. Few foods have been tested for their glycemic index, and the preparation and combination with other foods can alter its glycemic index. There is no requirement to display the glycemic index of a food product, and it is not always easy to predict the glycemic index of certain foods. Switching from a high glycemic index diet to a low glycemic index diet can be made relatively easy. Switching white bread and pastas to whole grain, eating breakfast cereals from oats, bran or barley, add more fruits and vegetables when cooking and reducing potato consumption can all aid in lowering glycemic index.

“Micelle” refers to aggregates formed by surfactants that typically form when the surfactant is present in an aqueous composition, typically when the surfactant is used at a concentration above the critical micelle concentration (CMC). In micelles, the hydrophilic portions of the surfactant molecules contact the aqueous or the water phase, while the hydrophobic portions form the core of the micelle, which can encapsulate non-polar ingredient(s), for example, the non-polar compounds in the compositions described herein. Typically, the surfactants and/or co-surfactants in the compositions described herein aggregate in the emulsions and the aqueous liquids to form micelles, which contain the non-polar compound(s).

The hydrophilic portion(s) of the surfactant molecules are oriented toward the outside of the micelle, in contact with the aqueous medium, while the hydrophobic portion(s) of the surfactant molecules are oriented toward the center of the micelle, in contact with the non-polar compound(s), which is contained in the center of the micelle. The micelles can contain more than one surfactant. In some embodiments, the micelles in the compositions described herein have an average particle size of about 1000 nm, typically, less than 500 nm or less than about 500 nm, typically less than 300 or less than about 300 nm, for example, less than 250 nm or less than about 250 nm, for example, less than 200 nm or less than about 200 nm, for example, less than or less than about 5, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 60, 70, 80, 90, 100, 110, 120, 130, 140, 150, 160, 170, 180, 190, or 200 nm.

Inverse micelles: are surfactant aggregates that typically form in lipophilic solutions, with the hydrophilic portions forming the core. When the cross sectional area of the hydrophobic region of the surfactant molecule is greater than that of the hydrophilic part of the molecule, the formation of micelles, which can be hexagonal phase structures, is favored.

Modified carbohydrate emulsion stabilizer. “fatty acid-modified carbohydrate emulsion stabilizer” and “fatty acid-modified carbohydrate-based macromolecule emulsion stabilizer” refer synonymously to emulsion stabilizers with balanced hydrophobic and hydrophilic properties, particularly gums and starches that are modified by reaction with fatty acids (see also, discussion below). These can be employed as co-emulsifiers with the surfactants, such as sucrose fatty acid esters (SFAE), in the compositions herein. The modified carbohydrate emulsion stabilizers, include, for example, gums and starches modified by reaction with any fatty acid chain containing from 6-30 carbons, such as an alkyl succinic anhydride, including n-octenyl succinic anhydride (OSAn), wherein the resulting modified gum or starch has hydrophobic (fatty acid chain) and hydrophilic (carbohydrate) properties and is an emulsion stabilizer.

Monatin: is a naturally occurring high intensity sweetener isolated from the plant sclerochiton ilicifolius, found in the Transvaal region of South Africa. Monatin contains no carbohydrates and no sugars and nearly no calories, unlike sucrose or other nutritive sweeteners at equal sweetness.

Monk Fruit Extract: provides all-natural, great-tasting, zero-calorie sweetness, extracted from the monk fruit. Monk fruit grows on lush vines in small farms in the sub-tropical climate of Asian hillsides, where temperate conditions and elevation are ideal.

The fruit is harvested by hand, then crushed and infused with hot water to release its natural sweetness. At around 200 times the sweetness of sugar and with exceptional stability, PUREFRUIT™ is appropriate for a wide range of food and beverage applications.

The vine attains a length of 3 to 5 m, climbing over other plants by means of tendrils which twine round anything they touch. The narrow, heart-shaped leaves are 10-20 cm long. The fruit is round, 5-7 cm in diameter, smooth, yellow-brownish or green-brownish in colour, containing striations from the fruit stem end of the furrows with a hard but thin skin covered by fine hairs. The inside of the fruit contains an edible pulp, which, when dried, forms a thin, light brown, brittle shell about 1 mm in thickness. The seeds are elongated and almost spherical. The fruit is sometimes mistaken for the unrelated purple mangosteen. The interior fruit is eaten fresh, and the bitter rind is used to make tea appropriately called luohan guo.

The monk fruit is notable for its sweetness, which can be concentrated from its juice. The fruit contains 25 to 38% of various carbohydrates, mainly fructose and glucose. The sweetness of the fruit is increased by the mogrosides, a group of triterpene glycosides (saponins). The five different mogrosides are numbered from I to V; the main component is mogroside V, which is also known as esgoside.

The plant is cultivated for its fruit, used for cooling drinks and in traditional Chinese medicine. The fruit extract is nearly 300 times sweeter than sugar and has been used as a natural low-calorie sweetener in China for nearly a millennium to treat diabetes and obesity. The fruit also contains vitamin C.

Nanoemulsion: is an emulsion in which the dispersed droplets, for example, the micelles, have an average diameter (particle size) less than 1000 nm or less than about 1000 nm, typically, less than 500 nm or less than about 500 nm, typically less than 300 nm or less than about 300 nm, for example, less than 250 nm or less than about 250 nm, for example, less than 200 nm or less than about 200 nm, for example, less than or less than about 5, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 60, 70, 80, 90, 100, 110, 120, 130, 140, 150, 160, 170, 180, 190, or 200 nm.

“Non-polar”. “lipophilic” and “lipid-soluble”: synonymously refer to compounds (e.g., non-polar compounds) and/or ingredients, for example, non-polar active ingredients, which have greater solubility in organic solvents (e.g., ethanol, methanol, ethyl ether, acetone, and benzene) and in fats and oils, than in aqueous liquids, for example, water.

Natural Sweetener: As used herein a natural sweetener is one that is naturally occurring. Such a sweetener can be that by way of example only; honey, sugar, fructose, monk fruit extract, monatin etc.

Non-polar compounds: include drugs, hormones, vitamins, nutrients and other lipophilic compounds that contain one or more non-polar active ingredients. Typically, the non-polar compounds used in the compositions described herein are poorly water soluble, for example, water insoluble or compounds having low water solubility. Exemplary non-polar compounds contain non-polar active ingredients, for example, lipid-soluble drugs, hormones, unsaturated fatty acids, for example, essential fatty acids, polyunsaturated fatty acids (PUFA), for example, omega-3, omega-6 and omega-9 fatty acids, vitamins, nutrients, nutraceuticals, minerals and other non-polar active ingredients. Additional exemplary non-polar compounds are described herein. The compositions described herein can be formulated with any non-polar compound, for example, containing any non-polar active ingredient.

Non-polar active ingredient: refers to a non-polar ingredient within a non-polar compound, that, when administered to a subject, for example, a human, induces or is proposed to induce a desired response, such as altering body function at the cellular, tissue, organ or other level, and/or altering cosmetic appearance or other property, or a non-polar compound or ingredient that is ingested in order to achieve a desired effect. Non-polar active ingredients can be any synthetic or natural non-polar ingredient or compound, including a pharmaceutical, drug, therapeutic, nutritional supplement, herb, hormone or other ingredient. Non-polar active ingredients can include the non-polar active ingredients listed herein, as well as other pharmaceutically acceptable or food-grade active derivatives of the active ingredients, for example, salts, esters, amides, prodrugs, active metabolites, isomers, fragments and analogs. Active ingredients can include compounds proven to have a desired effect and also compounds thought to produce such effects, for example, compounds typically ingested for nutritional supplementation purposes.

Non-polar solvent: refers to oils and other non-polar ingredients that dissolve non-polar compounds. In some embodiments, the non-polar solvent is an oil that is included in the composition in addition to the non-polar compound. For example, the non-polar solvent typically is not the non-polar compound itself, e.g., is distinct from the non-polar compound. Certain compounds, for example, flaxseed oil and safflower oil, can be non-polar solvents and non-polar compounds, or non-polar active ingredients. Typically, the non-polar solvent contains one or more oils, typically oils other than the non-polar active ingredient, or oil(s) not contained in the active ingredient. Exemplary non-polar solvents include, but are not limited to, oils (in addition to the non-polar active ingredient), for example, Vitamin E oil, oleic acid, flaxseed oil, CLA, Borage Oil, D-limonene, canola oil, corn oil, MCT oil and oat oil. Other oils also can be used. Exemplary of the Vitamin E oil is the oil sold by ADM Natural Health and Nutrition, Decatur, Ill., under the name Novatol™ 5-67 Vitamin E (D-alpha-Tocopherol; ADM product code 410217). This Vitamin E oil contains at least 67.2% Tocopherol and approximately 32.8% soybean oil. In one example, the non-polar solvent is referred to, synonymously as “non-polar solubilizer.” In one example, the non-polar compound is dissolved in a non-polar solvent in practicing the methods of producing the compositions described herein. In this example, the compositions described herein contain non-polar solvents in amounts sufficient to dissolve the non-polar compound. More than one non-polar solvent can be used.

Omega-3 (.omega.3; n-3) fatty acids: are methylene interrupted polyenes, which have two or more cis double bonds, separated by a single methylene group and in which the first double bond appears at the third carbon from the last (.omega.) carbon. Omega-3 fatty acids can be used as dietary supplements, for example, for disease treatment and prevention. In one example, the compositions described herein contain non-polar active ingredients that contain at least one omega-3 fatty acid. Omega-3 fatty acids suitable for the compositions described herein include any of those known in the art. Suitable omega-3 fatty acids include Alpha-Linolenic acid (.alpha.-Linolenic acid: ALA) (18:3.omega.3) (a short-chain fatty acid); Stearidonic acid (18:4.omega.3) (a short-chain fatty acid); Eicosapentaenoic acid (EPA) (20:5.omega.3); Docosahexaenoic acid (DHA) (22:6.omega.3); Eicosatetraenoic acid (24:4.omega.3); Docosapentaenoic acid (DPA, Clupanodonic acid) (22:5.omega.3); 16:3.omega.3; 24:5.omega.3 and nisinic acid (24:6.omega.3). Longer chain omega-3 fatty acids can be synthesized from ALA (the short-chain omega-3 fatty acid). Exemplary of non-polar active ingredients containing omega-3 fatty acids are non-polar active ingredients containing DHA and/or EPA, for example, containing fish oil, krill oil and/or algae oil, for example, microalgae oil, and non-polar active ingredients containing alpha-linolenic acid (ALA), for example, containing flaxseed oil.

Omega-3 Fatty Acid Compounds: Omega-3 fatty acid compounds suitable for the provided compositions herein include any of those known in the art. Suitable PUFA-containing active ingredients that can be used in the compositions described herein include compounds that contain one or more omega-3 (.omega.3: n-3) fatty acids, for example, compounds containing DHA and/or EPA fatty acids, for example, marine oils, for example, fish oil, krill oil and algae oil; and compounds containing ALA fatty acids, for example, flax seed oil.

Oils and aqueous compositions containing long-chained polyunsaturated fatty acids (PUFA) can be susceptible to oxidation, making them unstable and giving them an unpleasant taste. The ingredients and relative concentrations thereof, as well as the methods for making the concentrates, can contribute to desirable properties of DHA/EPA-containing concentrates. In one example, ingredients and methods minimize the “fishy” odor and/or taste of DHA/EPA compositions and increase their stability over time. In one aspect, the compounds in the concentrates have low oxidation, contributing to these desirable properties.

Omega-6 (.omega.-6; n-6) fatty acids: are methylene interrupted polyenes, which have two or more cis double bonds, separated by a single methylene group and in which the first double bond appears at the sixth carbon from the last (.omega.) carbon. In one example, the compositions described herein contain non-polar active ingredients that contain at least one omega-6 fatty acid. Omega-6 fatty acids suitable for the compositions described herein include any of those known in the art. Suitable omega-6 fatty acids include Linoleic acid (18:2.omega.6) (a short-chain fatty acid); Gamma-linolenic acid (GLA) (18:3.omega.6); Dihomo gamma linolenic acid (DGLA) (20:3.omega.6); Eicosadienoic acid (20:2.omega.6); Arachidonic acid (AA) (20:4.omega.6); Docosadienoic acid (22:2.omega.6); Adrenic acid (22:4.omega.6); and Docosapentaenoic acid (22:5.omega.6). Suitable non-polar active ingredients containing omega-6 fatty acids include ingredients containing GLA, for example, borage oil. Additional suitable PUFA-containing non-polar active ingredients include compounds containing conjugated fatty acids, for example, conjugated linoleic acid (CLA) and compounds containing saw palmetto extract.

Omega-6 Compounds: Omega-6 fatty acid compounds suitable for the compositions described herein include any of those known in the art. Suitable non-polar compounds used in the compositions described herein include compounds containing omega-6 PUFAs, for example, gamma-linolenic acid (GLA), for example, borage oil and evening primrose (Oenothera biennis) oil, blackcurrant seed oil, hemp seed oil, fungal oil and spirulina extract. Other oils containing omega-6 fatty acids can be used in the compositions described herein.

“Polyunsaturated fatty acid” and “PUFA”: are used synonymously to refer to fatty acids that contain more than one carbon-carbon double bond in the carbon chain of the fatty acid. PUFAs, particularly essential fatty acids, are useful as dietary supplements. PUFAs suitable for the compositions described herein include any of those known in the art, including short chain, medium chain, and long chain PUFAs (e.g., omega-3, omega-6, or omega-9 fatty acids). In some embodiments, the compositions described herein include at least one polyunsaturated fatty acid selected from the group consisting of hexadecatrienoic acid, alpha-linolenic acid, stearidonic acid, eicosatrienoic acid, eicosatetraenoic acid, eicosapentaenoic acid, heneicosapentaenoic acid, docosapentaenoic acid (n-3), docosahexacnoic acid, tctracosapentaenoic acid, tetracosahexaenoic acid, linoleic acid, gamma-linolenic acid, eicosadienoic acid, dihomo-gamma-linolenic acid, arachidonic acid, docosadienoic acid, adrenic acid, docosapentaenoic acid (n-6), tetracosatetraenoic acid, tetracosapentaenoic acid, mead acid, and a mixture thereof. In some embodiments, the compositions described herein include at least one polyunsaturated fatty acid selected from the group consisting of eicosapentaenoic acid, docosapentaenoic acid (n-3), docosahexaenoic acid, arachidonic acid, and docosapentaenoic acid (n-6). Suitable amount and forms of PUFAs include those described herein.

Preservative: refers to ingredients that can improve stability of the compositions described herein. Preservatives, particularly food and beverage preservatives, are well known. Any known preservative can be used in the compositions described herein. Suitable preservatives that can be used in the compositions described herein include oil soluble preservatives, for example, benzyl alcohol, Benzyl Benzoate, Methyl Paraben, Propyl Paraben, antioxidants, for example, Vitamin E. Vitamin A Palmitate and Beta Carotene. Typically, a preservative is selected that is safe for human consumption, for example, in foods and beverages, for example, a GRAS certified and/or Kosher-certified preservative, for example, benzyl alcohol.

Shelf life: refers to a time period within which the compositions described herein remain stable, for example, the ability of the compositions described herein to remain stable, i.e., free from one or more changes over a period of time. In one example, the compositions are stable if they exhibit one or more of these described characteristics, over time, when kept at a particular temperature. In one example, the compositions remain stable at room temperature, for example, 25° C. or about 25° C. In another example, the compositions remain stable at between 19° C. and 25° C. In another example, the compositions remain stable at refrigerated temperatures, for example, 4° C. or about 4° C., or at frozen temperature, for example, at −20° C. or about −20° C.

Supplement: (See Additive; Additive and Supplement as used herein have the same meaning)

Sweetener: includes sugars, which can be natural sweetener; and sugar substitutes, which are also a food additive that duplicates the effect of sugar in taste, usually with less food energy. Sugar substitutes can be natural or synthetic. In general those that are not natural are called artificial.

Turbid liquid: is one that is thick or opaque with visible particles in suspension, for example, a liquid that is cloudy or muddy in appearance. In another example, it can be desired that a composition appears more clear or as clear as another liquid, for example, a beverage (e.g., a carbonated beverage), for example, by having no more visible particles, no more crystal formation and/or no more cloudiness than the other liquid. In one example, the compositions described herein are clear. In another example, they are relatively clear or as clear as or about as clear as another composition, for example, a beverage that does not contain the non-polar compound or liquid emulsion concentrate.

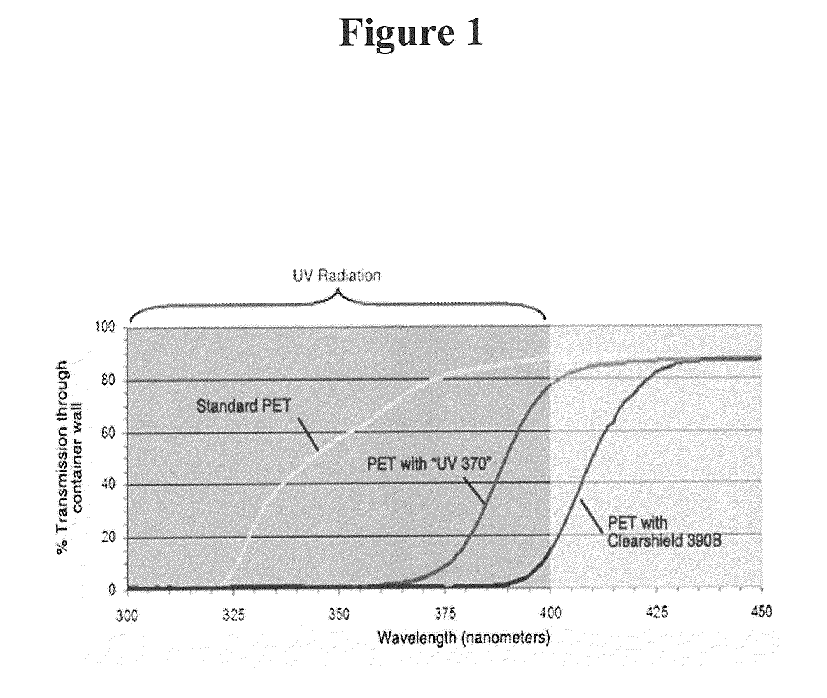

UV Blocking Packaging: Packaging that blocks at least 80% of UV Light. See FIG. 1.

“v/v”, “volume per volume”, “percent by volume” and “volume percent”: are used synonymously to express the ratio of the volume of one component of a composition and the volume of the entire composition.

“w/w,” “weight per weight,” “by weight”, “% by weight” and “weight percent”: are used synonymously used to express the ratio of the mass of one component of a composition compared to the mass of the entire composition. For example, when the amount of a particular ingredient represents 1%, by weight (w/w) of a concentrate, the mass of that ingredient is 1% of the mass of the entire concentrate. Similarly, when the amount of an ingredient is 50% (w/w) of the concentrate, the mass of that ingredient is 50% of the entire mass of the concentrate. Similarly, when a composition and/or a compound contains 10%, by weight of an ingredient, the mass of the ingredient is 10% of the total mass of the composition or compound. When only a concentration, amount, or percentage (without units) is listed, it is to be understood that the concentration or percentage is a concentration or percentage, by weight.

In some aspects, the present application provides a carbonated drink comprising an omega additive, wherein the carbonated drink is “low glycemic”, i.e., having a low glycemic index, and has an “enhanced” non-refrigerated shelf life.

In some embodiments, the non-refrigerated shelf life refers to shelf life obtained when the composition is exposed to sunlight and in non-refrigerated environment having a temperature of over 70° F. In some embodiments, the “enhanced” shelf life of the carbonated drink is achieved by a method comprising two or more of: a concentration of CO2 of greater than 0.5% (e.g., 0.5% to 7.0%), a nitrogen purge prior to crowning or closure, packaging having a transmission of UV light of less than 20%, and a pH within the range of 0.05 and 5.0. The shelf life is “enhanced” relative to otherwise similar beverages that do not practice embodiments disclosed herein. In some embodiments, the rancidity of the carbonated drink is reduced (e.g, prevented) by a method comprising two or more of: a concentration of CO2 greater than 0.5% (e.g., 0.5% to 7.0%), nitrogen purge prior to crowning or closure, a container that blocks 80% or more of UV light. In some embodiments, the microbial growth is restricted by having a concentration of CO2 greater than 0.5% (e.g., 0.5% to 7.0%).

In some embodiments, the carbonated drink has a concentration of CO2 of greater than 0.5% (e.g., 0.5% to 7.0%). In some embodiments, the carbonated drink comprises a omega-3 or omega-6 fatty acid. In some embodiments, the carbonated drink has a concentration of CO2 of greater than 0.5% (e.g., 0.5% to 7.0%) and one or more omega-3 fatty acids in an amount of 5 mg to 100 mg. Suitable omega-3, and omega-6 fatty acids include any of those described herein. In some embodiments, the omega additive is provided in an encapsulated form (e.g., as described herein). In some embodiments, the omega additive is provided with a reduced level of proteins and/or without mercury. In some embodiments, the omega additive in the carbonated drink comprises DHA and EPA. In some embodiments, the omega delivered in the carbonated drink comprises DHA+EPA of 32 mg or more per 10 oz of carbonated drink.

In any of the embodiments described herein, the carbonated drink can be characterized by one or more of the following: (a) the carbonated drink contains no binders; (b) the carbonated drink is of low turbidity: (c) the carbonated drink has no preservative; (d) the carbonated drink has no caffeine; (e) the carbonated drink is a cola drink; (f) the carbonated drink is a mostly clear soda; and (g) the carbonated drink comprises Fructose or Monk fruit extract.

In any of the embodiments described herein, the carbonated drink includes a bottling container component. The taste of the carbonated drink herein can be impacted by the bottling container component. For example, a bottle or container having aluminum outside with a food-grade internal lining comprised of a epoxy coating inside the bottle container that houses the carbonated drink (e.g., as described herein) provides the best taste. While the taste is acceptable in a PET bottle or container, it is believed that the epoxy coating which lines the inside of the aluminum bottle or container does not react or detract with the omega composition in the carbonated drink (e.g., as described herein) and therefore the taste is more natural and acceptable. Further the Aluminum outside provides a 100% UV block which awards the best protection from omega rancidity.

In some embodiments, a natural preservative, e.g., Natural Almond Preservative (Benzyl Alcohol) is included in the carbonated drink. This natural preservative provides both flavoring and also improves shelf life. In some embodiments, the carbonated drink does not include any preservative.

In some embodiments, the taste of the carbonated drink is impacted by adjusting a pH of the drink to 1 to 7 and the concentration of CO2 to greater than 0.5%.

The carbonated drink described herein has a highly acceptable taste, and leaves little, if any, after taste, has few, if any, digestive issues such as; burping, gas, indigestion. The carbonated drink described herein further does not leave the consumer with bad breath. The carbonated drink described herein can comprise caffeine or can be caffeine free. The carbonated drink described herein also can be made without binders and/or preservatives. The carbonated drink described herein can be that of a cola, or a clear soda. The carbonated drink described herein also is of low turbidity. The carbonated drink described herein can be of any flavor and one or more additional additives can be added.

In some aspects, the present application provides a carbonated drink that is characterized by having A) An acceptable taste, B) Appropriate Shelf Life and Stability, C) appropriate level of beneficial nutrition, and/or D) reduced side effects (including avoiding many known side effects) of Omega products. In some embodiments, the carbonated drink having the above characteristics is produced by a method comprising one or more of the following: (a) Reduction of omega proteins, (b) Encapsulation of the omega, (c) Packaging/bottling/container, and (d) Formulation of the carbonated drink. In some embodiments, the carbonated drink having the above characteristics is produced by a method comprising: (a) Reduction of omega proteins, (b) Encapsulation of the omega, (c) Packaging/bottling/container, and (d) Formulation of the carbonated drink.

Carbonated Drinks with Polyunsaturated Fatty Acids

Certain aspects of the present application are directed to a carbonated drink having one or more polyunsaturated fatty acids (e.g., an omega fatty acid) within the range of 12 mg to 75 mg per 10 oz of drink, CO2 greater than 0.5% (e.g., 0.5% to 7.0%). In some embodiments, the carbonated drink further comprises a Sweetener with a sweetness profile largely matching sugar with a Brix of syrup @20 C of 10 to 80 Brix. In some embodiments, the carbonated drink comprise a syrup having a pH (@20 C) of 0.05 to 5 (e.g., 1, 2, 3, 4, or 5) diluted with water in a ratio of between 1:3 and 1:7 by volume of the syrup to water.

In some embodiments, the carbonated drink described above is characterized by an enhanced shelf life, e.g., an enhanced shelf life when exposed to direct sunlight and in non-refrigerated environment having a temperature of over 70° F. In some embodiments, the enhanced shelf life is achieved by a method comprising one or more of: (a) a CO2 concentration of greater than 0.5% (e.g., 0.5% to 7.0%); (b) a nitrogen purge prior to crowning or closure; and (c) packaging having a transmission of UV light of less than 20%. In some embodiments, the method comprises (a), (b), and (c). In some embodiments, the method prevents omega rancidity of the drink.

In some embodiments, the carbonated drink described above comprises a omega-3 or omega-6 fatty acid. In some embodiments, the carbonated drink has a concentration of CO2 of 0.5% to 7.0 and one or more omega-3 fatty acids in an amount of 5 mg to 100 mg. Suitable omega-3, and omega-6 fatty acids include any of those described herein. In some embodiments, the one or more polyunsaturated fatty acids (e.g., an omega fatty acid) is provided in an encapsulated form (e.g., as described herein). In some embodiments, one or more polyunsaturated fatty acids (e.g., an omega fatty acid) is provided with a reduced level of proteins and/or without mercury. In some embodiments, the one or more polyunsaturated fatty acids (e.g., an omega fatty acid) in the carbonated drink comprises DHA and EPA. In some embodiments, the one or more polyunsaturated fatty acids (e.g., an omega fatty acid) delivered in the carbonated drink comprises DHA+EPA of 32 mg or more per 10 oz of carbonated drink.

In any of the embodiments described herein, the carbonated drink can be characterized by one or more of the following: (a) the carbonated drink contains no binders; (b) the carbonated drink is of low turbidity; (c) the carbonated drink has no preservative; (d) the carbonated drink has no caffeine; (e) the carbonated drink is a cola drink; (f) the carbonated drink is a mostly clear soda; (g) the carbonated drink is a non-cola soda; and (h) the carbonated drink comprises Fructose, Monk fruit extract, or Monatin.

In any of the embodiments described herein, the carbonated drink can be packaged in a metal container (e.g., aluminum container), a UV blocking PET container, or a UV blocking glass container. In some embodiments, the container blocks at least 80% of UV light.

In any of the embodiments described herein, the carbonated drink can have one or more sweeteners, for example, a natural sweetener and/or an artificial sweetener. Suitable natural or artificial sweeteners include those described herein.

In any of the embodiments described herein, the carbonated drink can have one or more flavoring agents, for example, fruit flavors, such as guava, kiwi, peach, mango, papaya, pineapple, banana, strawberry, raspberry, blueberry, orange, grapefruit, tangerine, lemon, lime and lemon-lime; cola flavors, tea flavors, coffee flavors, chocolate flavors, dairy flavors, root beer and birch beer flavor. Other suitable flavoring agents include those described herein.

In some embodiments, a natural preservative, e.g., Natural Almond Preservative (Benzyl Alcohol) is included in the carbonated drink. In some embodiments, the carbonated drink does not include any preservative. In some embodiments, the carbonated drink includes caffeine. In some embodiments, the carbonated drink does not include caffeine.

In some embodiments, the carbonated beverage described hereinabove further comprises at least one ingredient selected from the group consisting of vitamins, minerals, fiber, pH adjusters, emulsion stabilizers, non-polar solvents, phytochemicals, lipoic acid, coenzymes, sweeteners, caffeine, flavors, preservatives, and surfactants.

It should also be stated that while the examples of the present application relate to carbonated drinks having an omega fatty acid, non-carbonated drinks comprising an omega fatty acid are also contemplated. As with the carbonated drinks, the non-carbonated contemplated can also be with or without caffeine. As used herein, drink and beverage are used interchangeably.

It is believed the carbonated drink described herein represents the first viable commercial product that is a carbonated drink comprising an omega nutrient having a commercially acceptable taste and without the side effects that have plagued all prior failed commercial attempts. In addition, the drinks disclosed herein have an “enhanced” shelf life (e.g., as described herein) with reduced rancidity, both of which are appealing for the beverage market.

### EXAMPLES

### Example 1

### Formulations 1-26 of Carbonated Drinks Containing Omega

Exemplary Formulation 1 comprising 10 oz of carbonated drink:
#1) Omega; within the range of 12 mg to 75 mg per 10 oz of carbonated drink
#2) CO2: within the range of 0.5% to 7.0% v/v
#3) Fructose: with a Brix of syrup @20 C of 10 to 80 Brix
#4) Cola Flavored Soda: Flavor and Acid: with a water to syrup ratio of 1 part syrup to 3 parts water, up to a 1 part syrup to 7 parts water
#5) PH of Syrup: @20 C 0.05 to 5
#6) Açai Solution: Less than 5 mg
#7) Packaging: That blocks more than 80% of UV light
#8) Additional flavoring is optional; such an additional flavoring or flavorings could come from artificial and/or natural sources.

Exemplary Formulation 1 is packaged in a metal bottle that blocks 100% UV light and prior to the bottle cap being added was purged in nitrogen to remove most, if not all, O2 from the bottled drink. The omega of Exemplary Formulation 1 can be that of one or a combination of Omega 3, 6, 9. The omega can comprise encapsulation and protein reduction as taught in US 2012/0016026 A1, US 2011/0236364 A1 and US 2011/0117184 A1.

Exemplary Formulation 2 comprising 10 oz of carbonated drink:
#1) Omega; within the range of 12 mg to 75 mg per 10 oz of carbonated drink
#2) CO2: within the range of 0.5% to 7.0% v/v
#3) Monk Fruit Extract: 0.1 mg to 10 mg per 10 oz
#4) Cola Flavored Soda: Flavor and Acid: with a water to syrup ratio of 1 part syrup to 3 parts water, up to a 1 part syrup to 7 parts water
#5) PH of Syrup: @20 C 0.05 to 5
#6) Açai Solution: Less than 5 mg
#7) Packaging: That blocks more than 80% of UV light
#8) Additional flavoring is optional; such an additional flavoring or flavorings could come from artificial and/or natural sources.

Exemplary Formulation 2 is packaged in a bottle made of PET UV 370 that blocks 90%/o of UV light and prior to the bottle cap being added was purged in nitrogen to remove most, if not all, O2 from the bottled drink. The omega of Exemplary Formulation 2 can be that of one or a combination of Omega 3, 6, 9. The omega can comprise encapsulation and protein reduction as taught in US 2012/0016026 A1, US 2011/0236364 A1 and US 2011/0117184 A1.

Exemplary Formulation 3 comprising 10 oz of carbonated drink:
#1) Omega; within the range of 12 mg to 75 mg per 10 oz of carbonated drink
#2) CO2: within the range of 0.5% to 7.0% v/v
#3) Monk Fruit Extract: with a sweetness profile largely matching sugar with a Brix of syrup @20 C of 10 to 80 Brix.
#4) Cola Flavored Soda: Flavor and Acid: with a water to syrup ratio of 1 part syrup to 3 parts water, up to a 1 part syrup to 7 parts water
#5) PH of Syrup: @20 C 0.05 to 5
#6) Açai Solution: Less than 5 mg
#7) Packaging: That blocks more than 80% of UV light
#8) Additional flavoring is optional; such an additional flavoring or flavorings could come from artificial and/or natural sources.

Exemplary Formulation 3 is packaged in a bottle made of PET UV 370 that blocks 90% of UV light and prior to the bottle cap being added was purged in nitrogen to remove most, if not all, O2 from the bottled drink. The omega of Exemplary Formulation 3 can be that of one or a combination of Omega 3, 6, 9. The omega can comprise encapsulation and protein reduction as taught in US 2012/0016026 A1, US 2011/0236364 A1 and US 2011/0117184 A1.

Exemplary Formulation 4 comprising 10 oz of carbonated drink:
#1) Omega; within the range of 12 mg to 75 mg per 10 oz of carbonated drink
#2) CO2: within the range of 0.5% to 7.0% v/v
#3) Monk Fruit Extract: cut with Fructose and having a sweetness profile largely matching sugar with a Brix of syrup @20 C of 10 to 80 Brix.
#4) Cola Flavored Soda: Flavor and Acid: with a water to syrup ratio of 1 part syrup to 3 parts water, up to a 1 part syrup to 7 parts water
#5) PH of Syrup: @20 C 0.05 to 5
#6) Açai Solution: Less than 5 mg
#7) Packaging: That blocks more than 80% of UV light
#8) Additional flavoring is optional; such an additional flavoring or flavorings could come from artificial and/or natural sources.

Exemplary Formulation 4 is packaged in a bottle made of PET UV 370 that blocks 90% of UV light and prior to the bottle cap being added was purged in nitrogen to remove most, if not all, O2 from the bottled drink. The omega of Exemplary Formulation 4 can be that of one or a combination of Omega 3, 6, 9. The omega can comprise encapsulation and protein reduction as taught in US 2012/0016026 A1, US 2011/0236364 A1 and US 2011/0117184 A1.

Exemplary Formulation 5 comprising 10 oz of carbonated drink:
#1) Omega; within the range of 12 mg to 75 mg per 10 oz of carbonated drink
#2) CO2: within the range of 0.5% to 7.0% v/v
#3) Monk Fruit Extract: cut with another natural sweetener and largely having a sweetness profile mostly matching sugar with a Brix of syrup @20 C of 10 to 80 Brix.
#4) Cola Flavored Soda: Flavor and Acid: with a water to syrup ratio of 1 part syrup to 3 parts water, up to a 1 part syrup to 7 parts water
#5) PH of Syrup: @20 C 0.05 to 5
#6) Açai Solution: Less than 5 mg
#7) Packaging: That blocks more than 80% of UV light
#8) Additional flavoring is optional; such an additional flavoring or flavorings could come from artificial and/or natural sources.

Exemplary Formulation 5 is packaged in a bottle made of PET UV 370 that blocks 90% of UV light and prior to the bottle cap being added was purged in nitrogen to remove most, if not all, O2 from the bottled drink. The omega of Exemplary Formulation 5 can be that of one or a combination of Omega 3, 6, 9. The omega can comprise encapsulation and protein reduction as taught in US 2012/0016026 A1, US 2011/0236364 A1 and US 2011/0117184 A1.

Exemplary Formulation 6 comprising 10 oz of carbonated drink:
#1) Omega; within the range of 12 mg to 75 mg per 10 oz of carbonated drink
#2) CO2: within the range of 0.5% to 7.0% v/v
#3) Fructose: with a Brix of syrup @20 C of 10 to 80 Brix
#4) Non-Cola Flavored Soda: Flavor and Acid: with a water to syrup ratio of 1 part syrup to 3 parts water, up to a 1 part syrup to 7 parts water
#5) PH of Syrup: @20 C 0.05 to 5
#6) Açai Solution: Less than 5 mg
#7) Packaging: That blocks more than 80% of UV light
#8) Additional flavoring is optional; such an additional flavoring or flavorings could come from artificial and/or natural sources.

Exemplary Formulation 6 is packaged in a metal bottle that blocks 100% UV light and prior to the bottle cap being added was purged in nitrogen to remove most, if not all, O2 from the bottled drink. The omega of Exemplary Formulation 6 can be that of one or a combination of Omega 3, 6, 9. The omega can comprise encapsulation and protein reduction as taught in US 2012/0016026 A1, US 2011/0236364 A1 and US 2011/0117184 A1.

Exemplary Formulation 7 comprising 10 oz of carbonated drink:
#1) Omega; within the range of 12 mg to 75 mg per 10 oz of carbonated drink
#2) CO2: within the range of 0.5% to 7.0% v/v
#3) Monk Fruit Extract: with a sweetness profile largely matching sugar with a Brix of syrup @20 C of 10 to 80 Brix.
#4) Non-Cola Flavored Soda: Flavor and Acid: with a water to syrup ratio of 1 part syrup to 3 parts water, up to a 1 part syrup to 7 parts water
#5) PH of Syrup: @20 C 0.05 to 5
#6) Açai Solution: Less than 5 mg
#7) Packaging: That blocks more than 80% of UV light
#8) Additional flavoring is optional; such an additional flavoring or flavorings could come from artificial and/or natural sources.

Exemplary Formulation 7 is packaged in a bottle made of PET UV 370 that blocks 90% UV light and prior to the bottle cap being added was purged in nitrogen to remove most, if not all, O2 from the bottled drink. The omega of Exemplary Formulation 7 can be that of one or a combination of Omega 3, 6, 9. The omega can comprise encapsulation and protein reduction as taught in US 2012/0016026 A1, US 2011/0236364 A1 and US 2011/0117184 A1.

Exemplary Formulation 8 comprising 10 oz of carbonated drink:
#1) Omega; within the range of 12 mg to 75 mg per 10 oz of carbonated drink
#2) CO2: within the range of 0.5% to 7.0% v/v
#3) Monk Fruit Extract: cut with fructose and having sweetness profile largely matching sugar with a Brix of syrup @20 C of 10 to 80 Brix.
#4) Non-Cola Flavored Soda: Flavor and Acid: with a water to syrup ratio of 1 part syrup to 3 parts water, up to a 1 part syrup to 7 parts water
#5) PH of Syrup: @20 C 0.05 to 5
#6) Açai Solution: Less than 5 mg
#7) Packaging: That blocks more than 80% of UV light
#8) Additional flavoring is optional; such an additional flavoring or flavorings could come from artificial and/or natural sources.

Exemplary Formulation 8 is packaged in a bottle made of PET UV 370 that blocks 90% of UV light and prior to the bottle cap being added was purged in nitrogen to remove most, if not all, O2 from the bottled drink. The omega of Exemplary Formulation 8 can be that of one or a combination of Omega 3, 6, 9. The omega can comprise encapsulation and protein reduction as taught in US 2012/0016026 A1, US 2011/0236364 A1 and US 2011/0117184 A1.

Exemplary Formulation 9 comprising 10 oz of carbonated drink:
#1) Omega; within the range of 12 mg to 75 mg per 10 oz of carbonated drink
#2) CO2: within the range of 0.5% to 7.0% v/v
#3) Monk Fruit Extract: with a sweetness profile largely matching sugar with a Brix of syrup @20 C of 10 to 80 Brix.
#4) Non-Cola Flavored Soda: Flavor and Acid: with a water to syrup ratio of 1 part syrup to 3 parts water, up to a 1 part syrup to 7 parts water
#5) PH of Syrup: @20 C 0.05 to 5
#6) Açai Solution: Less than 5 mg
#7) Packaging: That blocks more than 80% of UV light
#8) Additional flavoring is optional; such an additional flavoring or flavorings could come from artificial and/or natural sources.

Exemplary Formulation 9 is packaged in a bottle made of PET UV 370 that blocks 90% of UV light and prior to the bottle cap being added was purged in nitrogen to remove most, if not all, O2 from the bottled drink. The omega of Exemplary Formulation 9 can be that of one or a combination of Omega 3, 6, 9. The omega can comprise encapsulation and protein reduction as taught in US 2012/0016026 A1., US 2011/0236364 A1 and US 2011/0117184 A1.

Exemplary Formulation 10 comprising 10 oz of carbonated drink:
#1) Omega; within the range of 12 mg to 75 mg per 10 oz of carbonated drink
#2) CO2: within the range of 0.5% to 7.0% v/v
#3) Monk Fruit Extract: cut with a natural sweetener and having a sweetness profile largely matching sugar with a Brix of syrup @20 C of 10 to 80 Brix.
#4) Non-Cola Flavored Soda: Flavor and Acid: with a water to syrup ratio of 1 part syrup to 3 parts water, up to a 1 part syrup to 7 parts water
#5) PH of Syrup: @20 C 0.05 to 5
#6) Açai Solution: Less than 5 mg
#7) Packaging: That blocks more than 80% of UV light
#8) Additional flavoring is optional; such an additional flavoring or flavorings could come from artificial and/or natural sources.

Exemplary Formulation 10 is packaged in a bottle made of PET UV 370 that blocks 90% of UV light and prior to the bottle cap being added was purged in nitrogen to remove most, if not all, O2 from the bottled drink. The omega of Exemplary Formulation 10 can be that of one or a combination of Omega 3, 6, 9. The omega can comprise encapsulation and protein reduction as taught in US 2012/0016026 A1, US 2011/0236364 A1 and US 2011/0117184 A1.

Exemplary Formulation 11 comprising 10 oz of carbonated drink:
#1) Omega; within the range of 12 mg to 75 mg per 10 oz of carbonated drink
#2) CO2: within the range of 0.5% to 7.0% v/v
#3) Artificial Sweetener: with a sweetness profile largely matching sugar with a Brix of syrup @20 C of 10 to 80 Brix.
#4) Non-Cola Flavored Soda: Flavor and Acid: Flavor and Acid: with a water to syrup ratio of 1 part syrup to 3 parts water, up to a 1 part syrup to 7 parts water
#5) PH of Syrup: @20 C 0.05 to 5
#6) Açai Solution: Less than 5 mg
#7) Packaging: That blocks more than 80% of UV light
#8) Additional flavoring is optional; such an additional flavoring or flavorings could come from artificial and/or natural sources.

Exemplary Formulation 11 is packaged in a metal bottle that blocks 100% UV light and prior to the bottle cap being added was purged in nitrogen to remove most, if not all, O2 from the bottled drink. The omega of Exemplary Formulation 11 can be that of one or a combination of Omega 3, 6, 9. The omega can comprise encapsulation and protein reduction as taught in US 2012/0016026 A1, US 2011/0236364 A1 and US 2011/0117184 A1.

Exemplary Formulation 12 comprising 10 oz of carbonated drink:
#1) Omega; within the range of 12 mg to 75 mg per 10 oz of carbonated drink
#2) CO2: within the range of 0.5% to 7.0% v/v
#3 Artificial Sweetener: with a sweetness profile largely matching sugar with a Brix of syrup @20 C of 10 to 80 Brix.
#4) Cola Flavored Soda: Flavor and Acid: Flavor and Acid: with a water to syrup ratio of 1 part syrup to 3 parts water, up to a 1 part syrup to 7 parts water
#5) PH of Syrup: @20 C 0.05 to 5
#6) Açai Solution: Less than 5 mg
#7) Packaging: That blocks more than 80% of UV light
#8) Additional flavoring is optional: such an additional flavoring or flavorings could come from artificial and/or natural sources.

Exemplary Formulation 12 is packaged in a metal bottle that blocks 100% UV light and prior to the bottle cap being added was purged in nitrogen to remove most, if not all, O2 from the bottled drink. The omega of Exemplary Formulation 12 can be that of one or a combination of Omega 3, 6, 9. The omega can comprise encapsulation and protein reduction as taught in US 2012/0016026 A1, US 2011/0236364 A1 and US 2011/0117184 A1.

Exemplary Formulation 13 comprising 10 oz of carbonated drink:
#1) Omega; within the range of 12 mg to 75 mg per 10 oz of carbonated drink
#2) CO2: within the range of 0.5% to 7.0% v/v
#3 Monatin Sweetener: with a sweetness profile largely matching sugar with a Brix of syrup @20 C of 10 to 80 Brix.
#4) Non-Cola Flavored Soda: Flavor and Acid: Flavor and Acid: with a water to syrup ratio of 1 part syrup to 3 parts water, up to a 1 part syrup to 7 parts water
#5) PH of Syrup: @20 C 0.05 to 5
#6) Açai Solution: Less than 5 mg
#7) Packaging: That blocks more than 80% of UV light
#8) Additional flavoring is optional; such an additional flavoring or flavorings could come from artificial and/or natural sources.

Exemplary Formulation 13 is packaged in a metal bottle that blocks 100% UV light and prior to the bottle cap being added was purged in nitrogen to remove most, if not all, O2 from the bottled drink. The omega of Exemplary Formulation 13 can be that of one or a combination of Omega 3, 6, 9. The omega can comprise encapsulation and protein reduction as taught in US 2012/0016026 A1, US 2011/0236364 A1 and US 2011/0117184 A1.

Exemplary Formulation 14 comprising 10 oz of carbonated drink:
#1) Omega; within the range of 12 mg to 75 mg per 10 oz of carbonated drink
#2) CO2: within the range of 0.5% to 7.0% v/v
#3 Monatin Sweetener: with a sweetness profile largely matching sugar with a Brix of syrup @20 C of 10 to 80 Brix.
#4) Cola Flavored Soda: Flavor and Acid: Flavor and Acid: with a water to syrup ratio of 1 part syrup to 3 parts water, up to a 1 part syrup to 7 parts water
#5) PH of Syrup: @20 C 0.05 to 5
#6) Açai Solution: Less than 5 mg
#7) Packaging: That blocks more than 80% of UV light
#8) Additional flavoring is optional; such an additional flavoring or flavorings could come from artificial and/or natural sources.

Exemplary Formulation 14 is packaged in a metal bottle that blocks 100% UV light and prior to the bottle cap being added was purged in nitrogen to remove most, if not all, O2 from the bottled drink. The omega of Exemplary Formulation 14 can be that of one or a combination of Omega 3, 6, 9. The omega can comprise encapsulation and protein reduction as taught in US 2012/0016026 A1, US 2011/0236364 A1 and US 2011/0117184 A1.

Exemplary Formulation 15 comprising 10 oz of carbonated drink:
#1) Omega; within the range of 12 mg to 75 mg per 10 oz of carbonated drink
#2) CO2: within the range of 0.5% to 7.0% v/v
#3) Natural Sweetener: with a sweetness profile largely matching sugar with a Brix of syrup @20 C of 10 to 80 Brix.
#4) Non-Cola Flavored Soda: Flavor and Acid: Flavor and Acid: with a water to syrup ratio of 1 part syrup to 3 parts water, up to a 1 part syrup to 7 parts water
#5) PH of Syrup: @20 C 0.05 to 5
#6) Açai Solution: Less than 5 mg
#7) Packaging: That blocks more than 80% of UV light
#8) Additional flavoring is optional; such an additional flavoring or flavorings could come from artificial and/or natural sources.

Exemplary Formulation 15 is packaged in a metal bottle that blocks 100% UV light and prior to the bottle cap being added was purged in nitrogen to remove most, if not all, O2 from the bottled drink. The omega of Exemplary Formulation 15 can be that of one or a combination of Omega 3, 6, 9. The omega can comprise encapsulation and protein reduction as taught in US 2012/0016026 A1, US 2011/0236364 A1 and US 2011/0117184 A1.

Exemplary Formulation 16 comprising 10 oz of carbonated drink:
#1) Omega; within the range of 12 mg to 75 mg per 10 oz of carbonated drink
#2) CO2: within the range of 0.5% to 7.0% v/v
#3) Natural Sweetener: with a sweetness profile largely matching sugar with a Brix of syrup @20 C of 10 to 80 Brix.
#4) Cola Flavored Soda: Flavor and Acid: Flavor and Acid: with a water to syrup ratio of 1 part syrup to 3 parts water, up to a 1 part syrup to 7 parts water
#5) PH of Syrup: @20 C 0.05 to 5
#6) Açai Solution: Less than 5 mg
#7) Packaging: That blocks more than 80% of UV light
#8) Additional flavoring is optional; such an additional flavoring or flavorings could come from artificial and/or natural sources.

Exemplary Formulation 16 is packaged in a metal bottle that blocks 100% UV light and prior to the bottle cap being added was purged in nitrogen to remove most, if not all, O2 from the bottled drink. The omega of Exemplary Formulation 16 can be that of one or a combination of Omega 3, 6, 9. The omega can comprise encapsulation and protein reduction as taught in US 2012/0016026 A1, US 2011/0236364 A1 and US 2011/0117184 A1.

Exemplary Formulation 17 comprising 10 oz of inventive beverage:
#1) Omega; within the range of 12 mg to 75 mg per 10 oz of carbonated drink
#2) Natural Sweetener: with a sweetness profile largely matching sugar with a Brix of syrup @20 C of 10 to 80 Brix.
#3) Non-Cola Flavored drink: Flavor and Acid: Flavor and Acid: with a water to syrup ratio of 1 part syrup to 3 parts water, up to a 1 part syrup to 7 parts water
#4) PH of Syrup: @20 C 0.05 to 5
#5) Açai Solution: Less than 5 mg
#6) Packaging: That blocks more than 80% of UV light
#7) Additional flavoring is optional; such an additional flavoring or flavorings could come from artificial and/or natural sources.

Exemplary Formulation 17 is packaged in a metal bottle that blocks 100% UV light and prior to the bottle cap being added was purged in nitrogen to remove most, if not all, O2 from the bottled drink. The omega of Exemplary Formulation 15 can be that of one or a combination of Omega 3, 6, 9. The omega can comprise encapsulation and protein reduction as taught in US 2012/0016026 A1, US 2011/0236364 A1 and US 2011/0117184 A1.

Exemplary Formulation 18 comprising 10 oz of inventive beverage:
#1) Omega; within the range of 12 mg to 75 mg per 10 oz of carbonated drink
#2) Natural Sweetener: with a sweetness profile largely matching sugar with a Brix of syrup @20 C of 10 to 80 Brix.
#3) Cola Flavored drink: Flavor and Acid: Flavor and Acid: with a water to syrup ratio of 1 part syrup to 3 parts water, up to a 1 part syrup to 7 parts water
#4) PH of Syrup: @20 C 0.05 to 5
#5) Açai Solution (optional): Less than 5 mg
#6) Packaging: That blocks more than 80% of UV light
#7) Additional flavoring is optional; such an additional flavoring or flavorings could come from artificial and/or natural sources.

Exemplary Formulation 18 is packaged in a metal bottle that blocks 100% UV light and prior to the bottle cap being added was purged in nitrogen to remove most, if not all, O2 from the bottled drink. The omega of Exemplary Formulation 15 can be that of one or a combination of Omega 3, 6, 9. The omega can comprise encapsulation and protein reduction as taught in US 2012/0016026 A1, US 2011/0236364 A1 and US 2011/0117184 A1.

Exemplary Formulation 19 comprising 10 oz of inventive beverage:
#1) Omega; within the range of 12 mg to 75 mg per 10 oz of carbonated drink
#2) Natural Sweetener: with a sweetness profile largely matching sugar with a Brix of syrup @20 C of 10 to 80 Brix.
#3) Non-Cola Flavored drink: Flavor and Acid: Flavor and Acid: with a water to syrup ratio of 1 part syrup to 3 parts water, up to a 1 part syrup to 7 parts water
#4) PH of Syrup: @20 C 0.05 to 5
#5) Açai Solution (optional): Less than 5 mg
#6) Packaging: That blocks more than 80% of UV light
#7) Natural Almond Preservative (Benzyl Alcohol): 2 mg-25 mg per 10 oz serving

Exemplary Formulation 19 is packaged in a metal bottle that blocks 100% UV light and prior to the bottle cap being added was purged in nitrogen to remove most, if not all, O2 from the bottled drink. The omega of Exemplary Formulation 15 can be that of one or a combination of Omega 3, 6, 9. The omega can comprise encapsulation and protein reduction as taught in US 2012/0016026 A1, US 2011/0236364 A1 and US 2011/0117184 A1.

Exemplary Formulation 20 comprising 10 oz of inventive beverage:
#1) Omega; within the range of 12 mg to 75 mg per 10 oz of carbonated drink
#2) Natural Sweetener: with a sweetness profile largely matching sugar with a Brix of syrup @20 C of 10 to 80 Brix.
#3) Cola Flavored drink: Flavor and Acid: Flavor and Acid: with a water to syrup ratio of 1 part syrup to 3 parts water, up to a 1 part syrup to 7 parts water
#4) PH of Syrup: @20 C 0.05 to 5
#5) Açai Solution (optional): Less than 5 mg
#6) Packaging: That blocks more than 80% of UV light
#7) Natural Almond Preservative (Benzyl Alcohol): 2 mg-25 mg per 10 oz serving

Exemplary Formulation 20 is packaged in a metal bottle that blocks 100% UV light and prior to the bottle cap being added was purged in nitrogen to remove most, if not all, O2 from the bottled drink. The omega of Exemplary Formulation 15 can be that of one or a combination of Omega 3, 6, 9. The omega can comprise encapsulation and protein reduction as taught in US 2012/0016026 A1, US 2011/0236364 A1 and US 2011/0117184 A1.

Exemplary Formulation 21 comprising 10 oz of carbonated drink:
#1) Omega; within the range of 12 mg to 75 mg per 10 oz of carbonated drink
#2) CO2: within the range of 0.5% to 7.0% v/v
#3) Fructose: with a Brix of syrup @20 C of 10 to 80 Brix
#4) Cola Flavored Soda: Flavor and Acid: with a water to syrup ratio of 1 part syrup to 3 parts water, up to a 1 part syrup to 7 parts water
#5) PH of Syrup: @20 C 0.05 to 5
#6) Açai Solution (optional): Less than 5 mg
#7) Packaging: That blocks more than 80% of UV light
#8) Natural Almond Preservative (Benzyl Alcohol): 2 mg-25 mg per 10 oz serving

Exemplary Formulation 21 is packaged in a metal bottle that blocks 100% UV light and prior to the bottle cap being added was purged in nitrogen to remove most, if not all, O2 from the bottled drink. The omega of Exemplary Formulation 1 can be that of one or a combination of Omega 3, 6, 9. The omega can comprise encapsulation and protein reduction as taught in US 2012/0016026 A1, US 2011/0236364 A1 and US 2011/0117184 A1.

Exemplary Formulation 22 comprising 10 oz of carbonated drink:
#1) Omega; within the range of 12 mg to 75 mg per 10 oz of carbonated drink
#2) CO2: within the range of 0.5% to 7.0% v/v
#3) Fructose: with a Brix of syrup @20 C of 10 to 80 Brix
#4) Non-Cola Flavored Soda: Flavor and Acid: with a water to syrup ratio of 1 part syrup to 3 parts water, up to a 1 part syrup to 7 parts water
#5) PH of Syrup: @20 C 0.05 to 5
#6) Açai Solution (optional): Less than 5 mg
#7) Packaging: That blocks more than 80% of UV light
#8) Natural Almond Preservative (Benzyl Alcohol): 2 mg-25 mg per 10 oz serving

Exemplary Formulation 22 is packaged in a metal bottle that blocks 100% UV light and prior to the bottle cap being added was purged in nitrogen to remove most, if not all, O2 from the bottled drink. The omega of Exemplary Formulation 1 can be that of one or a combination of Omega 3, 6, 9. The omega can comprise encapsulation and protein reduction as taught in US 2012/0016026 A1, US 2011/0236364 A1 and US 2011/0117184 A1.

It is most important to understand that while the carbonated drink is described above in various Exemplary Formulations of 10 oz volumes, the invention contemplates and teaches the carbonated drink being of any volume and adjusting the formulation of components accordingly. Further, any and all examples provided in this invention disclosure are by way of example only and not intended to be limiting.

Exemplary Formulation 23 comprising 10 oz of carbonated drink:
#1) Omega; within the range of 12 mg to 75 mg per 10 oz of carbonated drink
#2) CO2: within the range of 0.5% to 7.0% v/v
#3) Monk Fruit Extract: cut with Fructose and having a sweetness profile largely matching sugar with a Brix of syrup @20 C of 10 to 80 Brix.
#4) Cola Flavored Soda: Flavor and Acid: with a water to syrup ratio of 1 part syrup to 3 parts water, up to a 1 part syrup to 7 parts water
#5) PH of Syrup: @20 C 0.05 to 5
#6) Açai Solution (optional): Less than 5 mg
#7) Packaging: That blocks more than 80% of UV light
#8) Natural Almond Preservative (Benzyl Alcohol): 2 mg-25 mg per 10 oz serving

Exemplary Formulation 23 is packaged in a bottle made of PET UV 370 that blocks 90% of UV light and prior to the bottle cap being added was purged in nitrogen to remove most, if not all, O2 from the bottled drink. The omega of Exemplary Formulation 4 can be that of one or a combination of Omega 3, 6, 9. The omega can comprise encapsulation and protein reduction as taught in US 2012/0016026 A1, US 2011/0236364 A1 and US 2011/0117184 A1.

Exemplary Formulation 24 comprising 10 oz of carbonated drink:
#1) Omega; within the range of 12 mg to 75 mg per 10 oz of carbonated drink
#2) CO2: within the range of 0.5% to 7.0% v/v
#3) Monk Fruit Extract: cut with Fructose and having a sweetness profile largely matching sugar with a Brix of syrup @20 C of 10 to 80 Brix.
#4) Non-Cola Flavored Soda: Flavor and Acid: with a water to syrup ratio of 1 part syrup to 3 parts water, up to a 1 part syrup to 7 parts water
#5) PH of Syrup: @20 C 0.05 to 5
#6) Açai Solution (optional): Less than 5 mg
#7) Packaging: That blocks more than 80% of UV light
#8) Natural Almond Preservative (Benzyl Alcohol): 2 mg-25 mg per 10 oz serving

Exemplary Formulation 24 is packaged in a bottle made of PET UV 370 that blocks 90% of UV light and prior to the bottle cap being added was purged in nitrogen to remove most, if not all, O2 from the bottled drink. The omega of Exemplary Formulation 4 can be that of one or a combination of Omega 3, 6, 9. The omega can comprise encapsulation and protein reduction as taught in US 2012/0016026 A1, US 2011/0236364 A1 and US 2011/0117184 A1.

Exemplary Formulation 25 comprising 10 oz of carbonated drink:
#1) Omega; within the range of 12 mg to 75 mg per 10 oz of carbonated drink
#2) CO2: within the range of 0.5% to 7.0% v/v
#3 Monatin Sweetener: with a sweetness profile largely matching sugar with a Brix of syrup @20 C of 10 to 80 Brix.
#4) Cola Flavored Soda: Flavor and Acid: Flavor and Acid: with a water to syrup ratio of 1 part syrup to 3 parts water, up to a 1 part syrup to 7 parts water
#5) PH of Syrup: @20 C 0.05 to 5
#6) Açai Solution (Optional): Less than 5 mg
#7) Packaging: That blocks more than 80% of UV light
#8) Natural Almond Preservative (Benzyl Alcohol): 2 mg-25 mg per 10 oz serving

Exemplary Formulation 25 is packaged in a metal bottle that blocks 100% UV light and prior to the bottle cap being added was purged in nitrogen to remove most, if not all, O2 from the bottled drink. The omega of Exemplary Formulation 14 can be that of one or a combination of Omega 3, 6, 9. The omega can comprise encapsulation and protein reduction as taught in US 2012/0016026 A1, US 2011/0236364 A1 and US 2011/0117184 A1.

Exemplary Formulation 26 comprising 10 oz of carbonated drink:
#1) Omega; within the range of 12 mg to 75 mg per 10 oz of carbonated drink
#2) CO2: within the range of 0.5% to 7.0% v/v
#3 Monatin Sweetener: with a sweetness profile largely matching sugar with a Brix of syrup @20 C of 10 to 80 Brix.
#4) Cola Flavored Soda: Flavor and Acid: Flavor and Acid: with a water to syrup ratio of 1 part syrup to 3 parts water, up to a 1 part syrup to 7 parts water
#5) PH of Syrup: @20 C 0.05 to 5
#6) Açai Solution (Optional): Less than 5 mg
#7) Packaging: That blocks more than 80% of UV light
#8) Natural Almond Preservative (Benzyl Alcohol): 2 mg-25 mg per 10 oz serving

Exemplary Formulation 26 is packaged in a metal bottle that blocks 100% UV light and prior to the bottle cap being added was purged in nitrogen to remove most, if not all, O2 from the bottled drink. The omega of Exemplary Formulation 14 can be that of one or a combination of Omega 3, 6, 9. The omega can comprise encapsulation and protein reduction as taught in US 2012/0016026 A1, US 2011/0236364 A1 and US 2011/0117184 A1.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

All of the various aspects, embodiments, and options described herein can be combined in any and all variations.

All publications, patents, and patent applications mentioned in this specification are herein incorporated by reference to the same extent as if each individual publication, patent, or patent application was specifically and individually indicated to be incorporated by reference.

What is claimed is:

1. A beverage comprising one or more unsaturated fatty acids, wherein the beverage is a carbonated beverage characterized by a low glycemic index, an enhanced non-refrigerated shelf life, or a combination thereof.

2. The beverage of claim 1, wherein the one or more unsaturated fatty acids is provided in a form having a low protein content.

3. The beverage of claim 1, wherein the one or more unsaturated fatty acids comprise at least one unsaturated fatty acid selected from the group consisting of omega-3 fatty acids, omega-6 fatty acids, and omega-9 fatty acids.

4. The beverage of claim 1, wherein the one or more unsaturated fatty acids comprise at least one polyunsaturated fatty acid selected from the group consisting of hexadecatrienoic acid, alpha-linolenic acid, stearidonic acid, eicosatrienoic acid, eicosatetraenoic acid, eicosapentaenoic acid, heneicosapentaenoic acid, docosapentaenoic acid (n-3), docosahexaenoic acid, tetracosapentaenoic acid, tetracosahexaenoic acid, linoleic acid, gamma-linolenic acid, eicosadienoic acid, dihomo-gamma-linolenic acid, arachidonic acid, docosadienoic acid, adrenic acid, docosapentaenoic acid (n-6), tetracosatetraenoic acid, tetracosapentaenoic acid, mead acid, and a mixture thereof.

5. The beverage of claim 4, wherein the one or more unsaturated fatty acids comprise at least one polyunsaturated fatty acid selected from the group consisting of eicosapentaenoic acid, docosapentaenoic acid (n-3), docosahexaenoic acid, arachidonic acid, and docosapentaenoic acid (n-6).

6. The beverage of claim 1, wherein the one or more unsaturated fatty acids are provided in an encapsulated form.

7. The beverage of claim 1, having a CO₂ concentration in the range of 0.5% to 7.0% v/v.

8. The beverage of claim 1, wherein the beverage is included in a container that blocks 80% or more UV light.

9. A carbonated beverage comprising:
(a) one or more polyunsaturated fatty acids in an amount of 12 mg to 75 mg per 10 oz of the beverage;
(b) a CO₂ concentration in the range of 0.5% to 7.0% v/v; and
(c) a syrup having a pH of 0.05 to 5 diluted with water in a ratio of between 1:3 and 1:7 by volume of the syrup to water.

10. The carbonated beverage of claim 9, comprising a sweetener selected from the group consisting of fructose, Monk fruit extract, Monatin, and combinations thereof.

11. The carbonated beverage of claim 10, wherein the sweetener is Monatin.

12. The carbonated beverage of claim 10, wherein the sweetener is fructose.

13. The carbonated beverage of claim 9, wherein the beverage is included in a container that blocks 80% or more UV light.

14. The carbonated beverage of claim 9, wherein the one or more polyunsaturated fatty acids are provided in an encapsulated form.

15. The carbonated beverage of claim 9, wherein the one or more polyunsaturated fatty acids are provided in a form having a low protein level.

16. The carbonated beverage of claim 9, comprising at least one ingredient selected from the group consisting of vitamins, minerals, fiber, pH adjusters, emulsion stabilizers, non-polar solvents, phytochemicals, lipoic acid, coenzymes, sweeteners, caffeine, flavors, preservatives, and surfactants.

17. The carbonated beverage of claim 9, wherein the beverage has a low glycemic index.

18. The carbonated beverage of claim 9, wherein the beverage has an enhanced non-refrigerated shelf life.

19. The carbonated beverage of claim 9, wherein the beverage has a low turbidity.

20. The carbonated beverage of claim 9, comprising eicosapentaenoic acid and docosahexaenoic acid in an amount of 32 mg per 10 oz of the beverage.
